(19) United States
(12) Patent Application Publication
(10) Pub. No.: US 2026/0179169 A1
(43) Pub. Date: Jun. 25, 2026

(54) Methods for Mimicking Multi-Level Instancing with Non-Transforming Light-Weight Instances

(71) Applicant: NVIDIA Corporation, Santa Clara, CA (US)

(72) Inventor: Gregory MUTHLER, Chapel Hill, NC (US)

(21) Appl. No.: 18/990,071

(22) Filed: Dec. 20, 2024

(51) Int. Cl. G06T 1/20; G06T 15/06

(52) U.S. Cl. CPC G06T 1/20; G06T 15/06; G06T 2210/21

(57) ABSTRACT

Hardware support for light-weight instances achieve the effect of multi-level instancing without incurring associated performance or area cost, enabling a Cluster-Level AS (CLAS) to be used for a faster build speed. The same subdivision mechanism can also be used to reduce the complexity of the TLAS build by dividing instances into groups. Pseudo-Instance Nodes (PIN) allow for an indirection from a BVH node to any arbitrary location of a child complet. Multi-Parent Root Complets (MPRC) allow for any CLAS to be reused across multiple BLASs.

### CROSS-REFERENCE TO RELATED APPLICATIONS

None.

This application is related to the following commonly-owned patent applications, each of which is incorporated herein by reference for all purposes as if expressly set forth herein:

### FIELD

This technology relates to computer graphics, and to generation of visual effects based on instancing a virtual object so its instances appear in several or many locations in a virtual scene.

### BACKGROUND & SUMMARY

Many computer graphics systems use bounding volume hierarchies (BVHs) to accelerate visualization. Such a BVH is often generically referred to as an Acceleration Structure (AS) because it helps to accelerate graphics generation. ASes represent a hierarchy of bounding volumes that encapsulate smaller and smaller bounding volume subdivisions. Using a tree analogy, the largest volumetric bounding volume may be termed a “root node” and the smallest subdivisions of such hierarchy of bounding volumes (“leaf nodes”) contain items. The items could be primitives (e.g., polygons such as triangles) that define surfaces of the object. Or, an item could be a sphere that contains a whole new level of the world that exists as an item because it has not been added to the BVH (think of the collar charm on the cat from “Men in Black” which contained an entire miniature galaxy inside of it).

The BVH can be used to make a variety of graphics processes such as rendering and ray tracing faster and more efficient. A builder typically constructs the BVH in advance, e.g., based on specifications provided by a developer. “In advance” could be when a graphics application is developed, or in real time before the next video frame time during graphics generation, or both.

The graphics generation system is said to “traverse” the AS tree or graph to discover object representations it contains that are pertinent to the current visualization task, e.g., based on current viewpoint in a 3D world being visualized. Like a chef who prepares “mise en place” ingredients in advance of actually cooking anything, a builder prepares such ASes in advance to enable modern graphics generation systems to rapidly generate graphics presentations in real time response to user and other inputs.

Complex scenes in modern graphics applications are produced from vast numbers of primitives. This means that AS trees that used to have the extents of shrubs can now extend with huge canopies like banyan trees (but generally without the banyan's multiple trunks). Storing and accessing all those AS nodes can use lots of memory resources. Even more important, as a scene changes in a real time graphics application, graphics systems (in particular, builder software running on the graphics systems) are now asked to responsively build or modify the AS on the fly such as between video frames (which may each last only 1/30^{th} or 1/60^{th} of a second). As the AS tree or graph has grown in size, the time needed to build or modify it has grown correspondingly.

Therefore, graphics developers often wish to improve their ASes to make them both more compact and more efficient to build or change. They also desire computer graphics systems that can rapidly traverse and analyze such ASes without a huge memory footprint and associated memory bandwidth.

For such efficiency reasons, many ASes use something called “instancing” of objects to allow geometry to be reused within the scene. See for example U.S. Pat. No. 12,154,214 B2. Suppose a graphics designer wants to show Hadrian's Wall, which is constructed of millions of stone bricks stretching across England. Instead of individually modeling each brick, a graphics designer could create a model of a single brick, and replicate it many times to construct the wall. And instead of simply copying the brick model over and over again (which would occupy lots of storage space), the designer could store the brick model only once, and write compact instructions to size, place and orient each instance of the brick model into its place in the wall. The resulting compact representation maintains the complexity of Hadrian's wall structure without having to store potentially millions of individual brick models. Instancing thus can reduce memory usage by storing a single copy of virtual object geometry (e.g., a primitive or mesh data), with per instance data such as transformation matrices stored separately. This can reduce memory waste and avoid potential performance issues including memory thrashing.

Objects replicated many times in the scene at different positions, orientations and scales can thus be represented in the scene as instance nodes in an AS. These instance nodes associate a bounding box and leaf node in the world space BVH with a transformation that can be applied to transform from world space into an object coordinate space, and a pointer to an object-space BVH (that is, the instance node supplies both a pointer to geometry and a transform). The DirectX Raytracing (DXR) application programming interface (API) supports two levels of traversal: Top-Level AS (TLAS) and Bottom-Level AS (BLAS) corresponding to a world space and object space respectively. This avoids replicating the object space BVH data multiple times in world space, saving memory and associated memory accesses.

Using such techniques, geometry for a scene is described to the system using two levels of acceleration structures: Bottom-level acceleration structures (BLAS) each consist of a set of geometries that are building blocks for a scene, and a Top-level acceleration structure (“TLAS”) represents a set of instances of bottom-level acceleration structures. Within a given bottom-level acceleration structure, there can be any number of: (1) triangle meshes, or (2) procedural primitives initially described only by an axis aligned bounding box (AABB). Given a definition of a set of these geometries, the application asks the system to build an acceleration structure representing it into GPU memory owned by the application. This acceleration structure is what the system will use e.g., to intersect rays with the geometry. See e.g., DirectX Raytracing (DXR) Functional Spec v1.20 (Microsoft Jan. 11, 2023) found at microsoft.github.io/DirectX-Specs/d3d/Raytracing. html.

While transformation from object space to world space is also possible, the instance transform in many systems as described above increases efficiency by transforming a ray for ray tracing into object space instead of requiring the geometry or the bounding volume hierarchy to be transformed into world (ray) space (this is because it is generally far easier to transform a ray than to transform geometry), and is also compatible with additional, conventional rasterization processes that graphics processing performs to visualize the primitives. See for example US20210397449; U.S. Pat. Nos. 11,302,056; 11,380,041; 12,154,214.

Such instancing has been successfully used in many computer graphics systems to increase efficiency of computer graphics generation processes. However, as scenes increasingly add more geometric complexity, moving into the range of multi-billion or even trillions of triangles, at least one substantial bottleneck becomes apparent: the time required for the builder to build or update a suitable BVH generally increases linearly with the number of triangles. At extreme triangle counts, the BVH build time can push traversal performance outside of the real-time range.

One solution being employed is to increase the levels of instancing such that more parts of the scene can be built in parallel.

For example, imagine a car with millions of triangles. That car may previously have been a single object and instance. With additional levels of instancing though, the car could be further broken down into smaller cluster objects such that each part of the car could be built in parallel. Such a build might have 1000s of cluster objects each say 1000 triangles in size.

The parallel cluster object builds would feed a single object build which would consume instance-style bounding volumes rather than individual geometry to be sorted and built over. The combination of an easier object build with parallel cluster object builds can vastly improve the speed of the builder, allowing for continued real-time performance.

Meanwhile, techniques are also known for associating each instance in the AS with an associated level of detail (LOD) variant. Hierarchical instancing systems can manage multiple LODs by determining the correct LOD of an instance based e.g., on the position of that instance relative to the virtual camera. To increase efficiency, some systems group triangles clusters together in a hierarchy based on LOD. At run time, it is possible to find a cut of the hierarchical LOD tree of instances that matches the desired LOD in a view dependent way. Data may be streamed in on demand so that only visible detail needs to reside in memory, and different parts of an instanced object can be rendered at different levels of detail. During real time rendering, clusters may be swapped on the fly (i.e., between frames) at varying levels of detail based on the camera view. To avoid cracking between neighboring clusters within the same object, some such systems force each cluster in a group within the hierarchy make the same LOD decision for a given level.

There can be challenges to using such hierarchical LOD-based instance technology on current modern graphics engines/GPUs. For example, each cut in the LOD hierarchy (even one that may affect only a small number of triangles) can force a full rebuild of the acceleration structure (AS) in order to construct a good, fast BVH over all current triangles at current LODs. Additionally, LOD cuts at different LODs typically result in multiple different versions of a bottom level acceleration structure (“BLAS”), causing memory expansion. Furthermore, while each BLAS is composed of parts that can be selected in order to fit geometry together, sharing clusters across different versions of a BLAS may not work well for various reasons.

Thus, >2 levels of AS instancing may pose either a performance problem or an area problem. While >2 levels is supported by the ray tracing hardware in NVIDIA's current GPUs, it is not fully accelerated (i.e., needs software processor intervention to save/restore stacks) and so comes at some performance hit. Fully accelerating >2 levels can be trivially accomplished by extending existing support with additional storage (e.g., cluster-space ray, cluster-space stack, and cluster-space instancing information) but such a solution comes at a chip area cost.

### BRIEF DESCRIPTION OF THE DRAWINGS

FIG. 1 shows two BVH acceleration structures: a traditional AS on the left, and an improved AS having three instancing levels.

FIG. 2 illustrates two AS complet data replacement.

FIG. 3A shows example copying of complet content from one location to another.

FIG. 3B shows an example redirection layer.

FIGS. 4A and 4B show example different AS structures.

FIG. 5 shows an example stack protection.

FIG. 6 shows example AS multi-parent CLAS arrangements.

FIG. 7 shows example restructuring of the FIG. 6 CLAS to provide multi-parent single complets.

FIG. 8 shows an example AS structure with PIN indirection at a top instance level.

FIG. 9 shows an example builder flowchart to create the FIG. 8 AS structure.

FIG. 10 shows an example builder flowchart to create an AS.

FIGS. 11-15 show example complet data structures.

FIGS. 15A & 15B show example traversals of the corresponding ASes shown in FIGS. 4A & 4B.

FIG. 16 shows an example real time ray tracing graphics system.

FIG. 17 shows an example ray tracing shading pipeline.

FIG. 18 shows an example ray tracing test flowchart.

FIG. 19 shows an example ray tracing tree traversal unit (“TTU”).

FIG. 20 shows an example ray tracer processing.

FIG. 21A shows example ray tracer TLAS processing.

FIG. 21B shows example ray tracer BLAS processing.

FIG. 22 shows an example process to generate an image.

### DETAILED DESCRIPTION OF NON-LIMITING EMBODIMENTS

An example solution introduces hardware support for light-weight instances which achieves the effect of multi-level instancing without incurring associated performance or area cost. This for example enables a Cluster-Level AS (“CLAS”) to be used for a faster build speed. Example embodiments herein provide new hardware and associated arrangements that make such CLASes more efficient to build and use.

For example, such CLAS instancing can be used to subdivide a potentially massive scene into smaller coherent chunks of geometry whose overlaying BVHs can be built in parallel, leading to an improvement in BVH build time. This is particularly helpful when the BVH is constructed or modified at run time, e.g., between video frames to adapt to new user inputs, virtual camera position/orientation changes, object changes in the scene, etc.

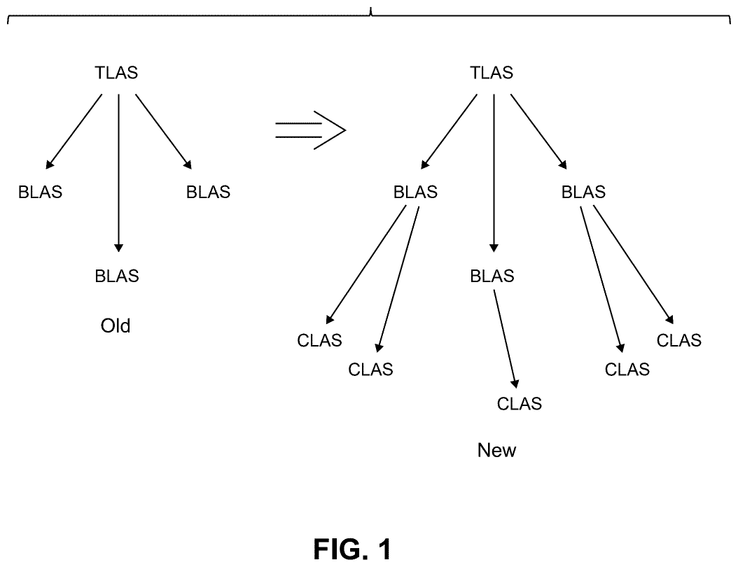

In particular, a CLAS sub-AS is created in a graphics system application programming interface (API) that alleviates the need for full AS rebuilds. In such example arrangements, the developer inputs triangles in cluster groups and then assembles clusters into objects in a conventional manner. An AS Builder uses these inputs to construct a CLAS over each cluster (if the clusters are small such as 128 triangles, this can be very fast). Such an API change with appropriate hardware support enables dramatically faster AS builds because the AS is now partitioned into a multiplicity CLASes each of which can be modified/replaced without the need to rebuild the entire AS. See e.g., FIG. 1. As one example use, a CLAS with a different LOD can be streamed in and built quickly without having to rebuild the entire AS.

In example embodiments, for each BLAS variant, the Builder builds a BLAS over a set of clusters such as shown in FIG. 1 (the builder can let the user provide which CLASes to construct the BLAS over or the builder can use its own heuristics). As FIG. 1 reflects, for the top-level build, a BLAS-over-CLASes is conceptually and structurally effectively the same as BLAS over triangles/primitives (just the BLAS internals are different). Cluster swaps can simply exchange one CLAS for another. The BLAS can be simply refit or possibly rebuilt. A build over triangles is typically slower than a refit, but a build over CLAS clusters can be very fast, e.g., it doesn't require re-sorting all triangles in the BLAS, which could potentially be a massive number of triangles.

The DXR specification and many current GPU hardware implementations accelerate 2 levels of instancing but do not fully support 3 instancing levels (the CLAS level of the AS is essentially a third instancing level) nor do they support reuse of CLASes across the BLAS. To meet this challenge, the present technology introduces a lightweight instancing scheme that effectively provides a third (or more) levels of instancing without incurring associated hardware and memory bandwidth costs that might be expected from adding another instancing level(s).

### Lightweight Instancing

The present technology introduces hardware support for lightweight instancing. As noted above, CLAS effectively create another level of instancing and the DXR specification currently supports only two levels of instancing. A third instancing level is functionally supported by current GPUs such as those provided by NVIDIA, but is not fully accelerated with full hardware support. In example embodiments, supporting a third level of instancing in hardware doesn't require full instancing hardware support either (e.g., no additional transform needed) and instead can take less memory footprint while executing what is needed just as efficiently.

The example non-limiting solution thus allows for reduced-cost instancing which enables high geometry count builds in real-time. An example non-limiting embodiment specifically forgoes any further transformations, ray flag modifications, and instance reporting while still supporting the logical split of an instance.

In example embodiments, the CLAS build may be exposed to the developer who would first pass in cluster-level geometry and then use the BVH built around that cluster-level geometry as input to a subsequent BLAS build. The same subdivision mechanism can also be used to reduce the complexity of the TLAS build by dividing instances into groups in a similar fashion.

### Two Independent Mechanisms: Pseudo-Instance Nodes & Multi-Parent Root Complets

Example embodiments herein introduce a lightweight instancing model in two parts and associated separate mechanisms that can be used together or separately:
Pseudo-Instance Nodes (“PIN”)
Multi-Parent Root Complets (“MPRC”).

### Pseudo-Instance Nodes (“PIN”)

PIN allows for an indirection from a compressed treelet (complet) in the BVH, which has implicit addressing, to any arbitrary location of a child complet. In one embodiment, PIN provides no transform or transform matrix (this is why it is called a “pseudo-instance node” instead of an “instance node” which typically provides a transform from one coordinate system to another)—just a redirection to the next instance level which in this case is a third, CLAS level. Thus, the new AS provides three instancing levels: a first (Top) Level TLAS, a second, (formerly) Bottom Level BLAS, and a third, CLAS level. The TLAS and BLAS each provide both a pointer and an instance transform. In particular, the TLAS can provide a first instance transform to locate, scale and rotate an instance of geometry into the scene, and the BLAS can provide a second instance transform to transform a ray from world space to the object space of the BLAS geometry for ray-geometry intersection testing. The third, CLAS level can be linked to the BLAS with a PIN that in contrast provides a pointer to the CLAS but no additional instance transform (note that the BLAS and the CLAS are both in object space). Such a pseudo-instance node is useful at least because it works with highly compressed complets/BVHs that use implicit addressing to save memory footprint. Furthermore, existing AS traversal hardware can otherwise process the CLAS (mostly) as if it were a third instancing level but without any additional transformation.

### Multi-Parent Root Complets (“MPRC”)

MPRC allows for any CLAS to be reused across multiple BLASs, reducing memory footprint. This involves for example enabling a given CLAS to be reached by any of a multiplicity of BLAS parent nodes. While MPRC provides performance gains for the BLAS build, MPRC may not necessarily be a useful addition in the top level (TLAS) PIN case.

Example Embodiments provide the following features alone or in combination.

A non-transitory memory storing an acceleration structure configured to control a graphics generator to generate a visualization, the acceleration structure comprising: a first level acceleration structure including an instance node; a second level acceleration structure linked to the first level acceleration structure, the second level acceleration structure including a pseudo-instance node; and a third level acceleration structure linked to the second level acceleration structure by the pseudo-instance node, wherein the acceleration structure defines a coordinate transform between the second level acceleration structure and the first level acceleration structure but defines no additional coordinate transform between the third level acceleration structure and the second level acceleration structure.

The second level acceleration structure is configured to apply the coordinate transform to transform geometry represented by the third level acceleration structure from object space to world space.

The geometry comprises a triangle cluster.

The pseudo-instance node comprises a pointer to the third level acceleration structure.

The second level acceleration structure comprises a first pseudo-instance node linking the second level acceleration structure to a first third level acceleration structure and a second pseudo-instance node linking the second level acceleration structure to a second third level acceleration structure.

The third level acceleration structure is linked to by a plurality of second level acceleration structures.

The first level acceleration structure comprises a first group acceleration structure and a second group acceleration structure, and a further pseudo-instance node links a top level acceleration structure root to each of the first group acceleration structure and the second group acceleration structure.

The pseudo-instance node comprises a multiplicity of pointers that point to a corresponding multiplicity of third level acceleration structures, the pointers comprising absolute or relative memory addresses.

Graphics generation hardware comprising: a memory interface configured to read an acceleration structure comprising: a first level acceleration structure including an instance node, a second level acceleration structure linked to the first level acceleration structure, the second level acceleration structure including a pseudo-instance node, and a third level acceleration structure linked to the second level acceleration structure by the pseudo-instance node, the acceleration structure defining a coordinate transform between the second level acceleration structure and the first level acceleration structure but defining no additional coordinate transform between the third level acceleration structure and the second level acceleration structure; a stack configured to store traversal of the acceleration structure, the acceleration structure further configuring the stack to prevent overwriting of a back track pointer from the third level acceleration structure to the second level acceleration structure; and a ray-geometry intersection testing circuit that applies the coordinate transform to transform geometry represented by the third level acceleration structure into a coordinate space of a ray.

A method of generating graphics comprising: accessing a TLAS acceleration structure;
accessing a BLAS acceleration structure through the TLAS acceleration structure including obtaining a transform; using a pseudo-instance node associated with the BLAS acceleration structure to access a CLAS acceleration structure defining geometry; and applying the transform to transform the geometry into a coordinate system associated with the TLAS acceleration structure.

A method of building an acceleration structure by automatically performing, with at least one processor or processing circuit, operations comprising: accessing at least one geometry cluster and using it to generate at least one corresponding CLAS; constructing at least one BLAS over the at least one corresponding CLAS using at least one of PIN and MPRC; constructing at least one TLAS over the at least one BLAS; and writing to memory an acceleration structure comprising the generated at least one corresponding CLAS, the at least one BLAS, and the at least one TLAS.

Constructing at least one TLAS over the at least one BLAS comprises: constructing a plurality of group TLASes over the at least one BLAS; constructing a TLAS over the plurality of group TLASes; and linking the TLAS with the plurality of group TLASes with at least one PIN.

The at least one BLAS and the at least one TLAS each define an instance transform whereas the PIN does not.

The PIN comprises a multiplicity of CLAS pointers.

The CLAS pointers are absolute addresses.

The CLAS pointers are relative addresses.

The at least one BLAS comprises at least one implicit address pointing to the PIN, and the comprises an absolute or relative address pointing to the at least one corresponding CLAS.

The MPRC enables the at least one corresponding CLAS to be called by any of plural BLASes.

A hardware ray tracing circuit comprising: a memory interface that reads portions of an acceleration structure from memory; a bounding box test circuit that culls acceleration structure nodes based on non-intersection of a ray with defined bounding boxes; a ray-geometry intersection circuit that tests geometry of non-culled acceleration structure nodes for intersection with the ray after transforming the ray from world space to object space of the geometry; and a stack that tracks visited nodes, the stack further storing an indication that a visited node it is a root complet having multi-parent/limited stack root.

The stack is further structured to lock an entry used to continue traversal to a particular one of multi-parent nodes.

Complet Background: Implicit Addressing and Why We Can't Just Put Anything Anywhere

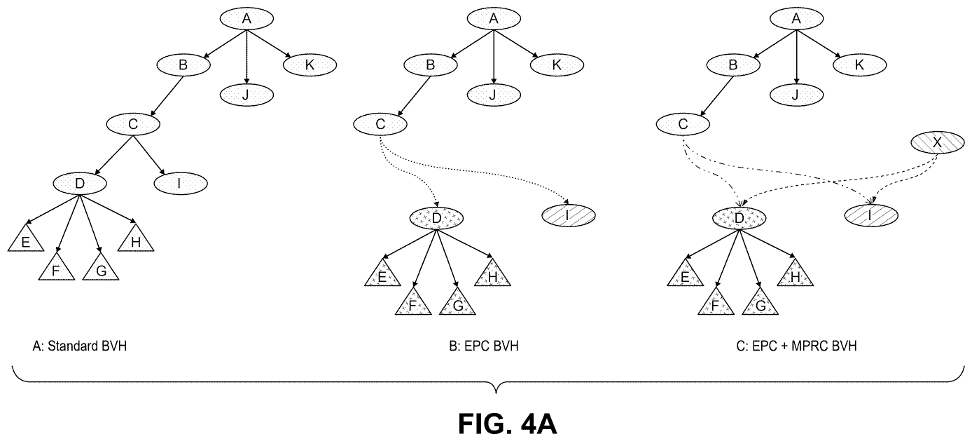

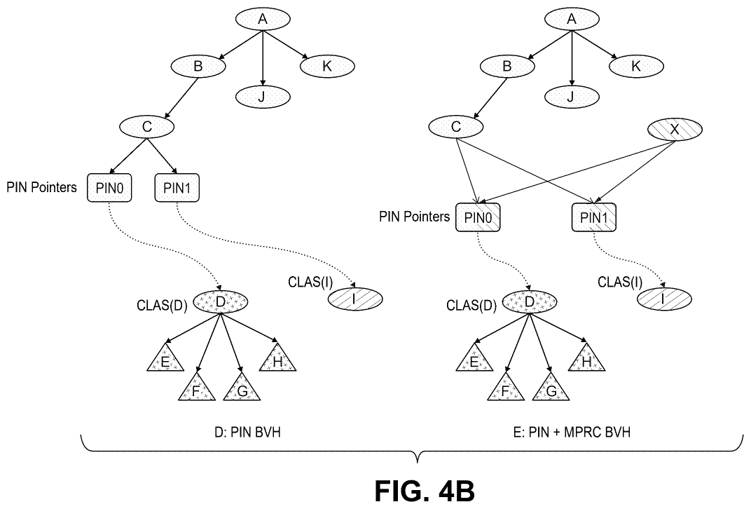

FIG. 4A, graph “A” shows an example of a standard BVH AS. Linkages between nodes within the hierarchal tree or graph structure of the BVH are provided by pointers within each AS node or complet. To save memory footprint, the complets use a compression technique involving implicit pointers to stuff many (e.g., 12) child complet pointers into a limited size memory block (e.g., a cache line sized 128B memory block). In one embodiment, a complet contains a child pointer that is a full or relative address to the first child complet, but subsequent children are implicitly addressed as fixed (e.g., 128B) increments from the previous child (e.g., complet child 0 is at location X, child 1 is at location X+128, and so on). This means all children of a complet are consecutive and stored contiguously in memory. Each child also has a single pointer back to its single parent to enable reverse traversal back up the BVH hierarchy for reasons that will be discussed below in detail.

Complets can also represent/point to leaves in the tree or graph that represent primitives such as triangles—that is, objects to be rendered. For leaf children, a leaf pointer points to the first primitive in a range (including items), plus the extent of that range. Subsequent leaf children start at the end of the previous range and go some distance further (either in lines, primitives, or both)

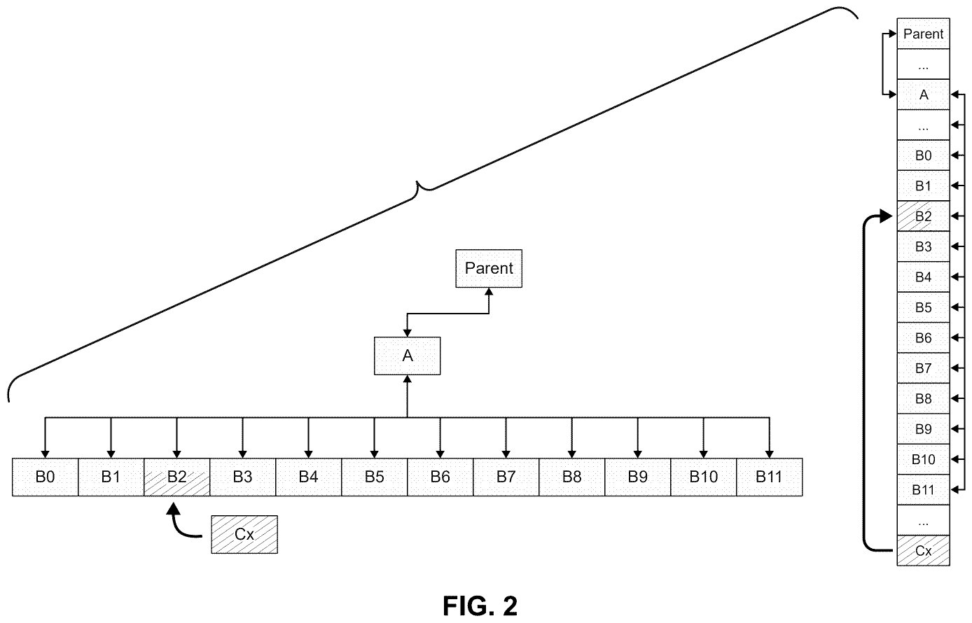

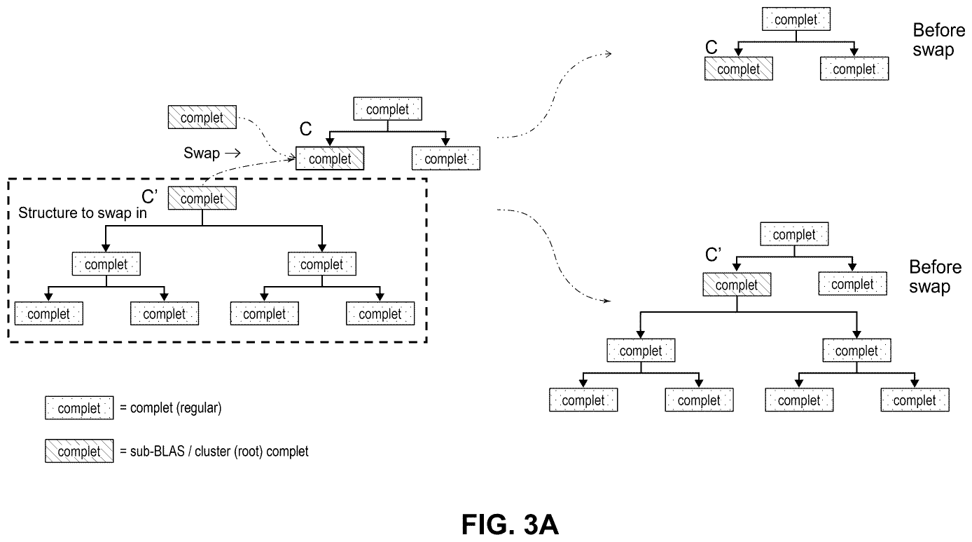

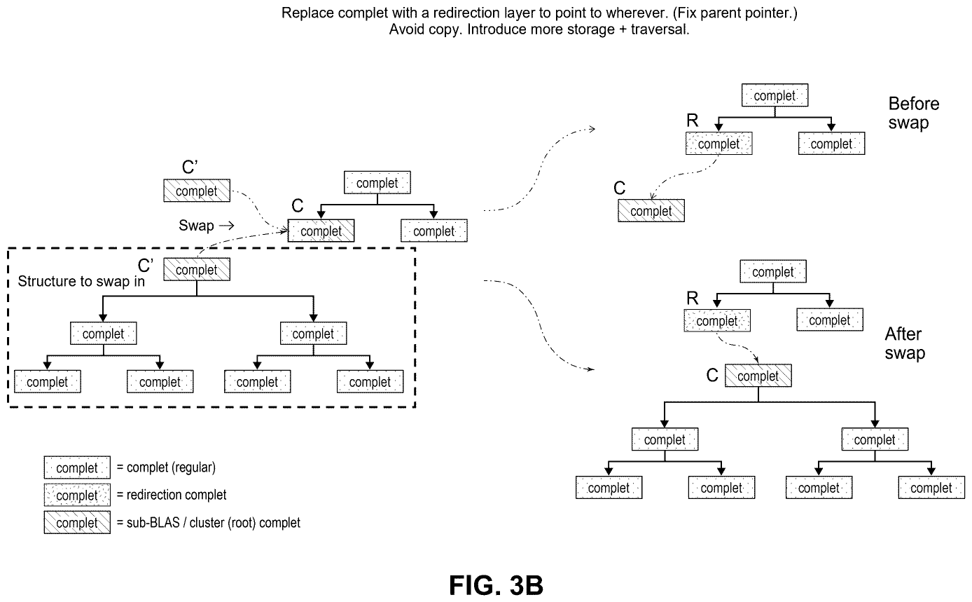

Using such a BVH acceleration structure, it is possible to change a portion of a scene by swapping out a portion of the AS with a replacement portion. Arbitrary swaps can be done by overwriting a child's complet and updating pointers. FIG. 2 shows an example of such a swap where child complet data Cx overwrites child complet data B2. As noted, child complets in the described legacy complet storage structure are stored consecutively and contiguously in memory, so a swap typically involves overwriting the complet data itself. For example, FIG. 3A illustrates memory copies involving copying over the complet C to be replaced with a different complet C′ linking to a different sub-structure and updating the parent pointer. In the case of a swap out and back in, the system may need to save the original complet C someplace else for swapping back in to return the scene to an earlier state. Managing memory for such swapping can be difficult for software to do, and can potentially require a lot of memory bandwidth as well for all the copying.

Because merely changing a pointer is often less expensive than making more invasive changes to the AS structure, another approach that could work is using a redirection complet such as shown in FIG. 3B. FIG. 3B shows how a single child complet (which in legacy systems has one explicit child address pointer) could act as a redirection point to redirect to a desired complet and associated sub-structure. A swap as shown in FIG. 3B now involves merely changing the redirection complet. But the AS is now using an entire complet worth of memory storage just to redirect to a single node at a single explicit address.

FIG. 4A graph “B” shows an alternative design that avoids implicit addressing by providing for explicit pointer complets (EPCs) that store the indirection address in the complet itself. This reduces child count (e.g., from 12 to 6 in one example) and uses the resulting space to encode explicit child/leaf addresses per child. Because each explicit child/leaf node address can point to anywhere within a given memory addressing space, this approach eliminates the constraint of storing child complets consecutively and contiguously in memory. FIG. 4A graph “B” also shows that the EPC approach preserves the same tree or graph structure as before, but at the expense of doubling size requirements of AS nodes using explicit addressing (recall from above that use of implicit addresses is a form of compression to save memory footprint).

### Pseudo Instance Nodes (PINs): Overview

Like EPC's, pseudo instance nodes (PINs) use explicit addresses in example embodiments. However, unlike EPC's, PINs instead move explicit addresses into a separate node so as to retain the full width (e.g., 12-wide) property of the complet. By maintaining the full width (e.g., 12-wide) property of the complet instead of dropping to a reduced width (e.g., 6-wide which would in EPC as described above, go along with explicit pointers), performance can be maintained even in the face of additional traffic to fetch the extra PIN. That is, it is better to cull more things quickly and run the unculled work more slowly than it is to cull fewer things in the same time even while perhaps running that unculled work quicker.

FIG. 4B graph “D” shows an example where AS nodes D/E/F/G/H define clusters including a CLAS(D) cluster node and a CLAS(I) cluster node. Node C includes (references) PINs to each of CLAS(D), CLAS(I). Specifically in this example, Node C points to CLAS(D) through its associated PIN0, and points to CLAS(I) through its associated PIN1. To swap out or replace CLAS(D) and/or CLAS(I) merely involves replacing the PIN(s) with new PIN(s) that points to a different CLAS.

### Multi-Parent Root Complets (MPRCs): Overview

Multi-Parent Root Complets (MPRC) meanwhile provide a mechanism for reusing a CLAS across multiple BLASs without replication. The basic solution: enable any number of BLAS nodes to point to the same CLAS root node. This seems simple: it's like giving each of your many friends your address so they can each find their way to your house for a party. The complication comes in making sure each of those friends can get back to their respective origin point after the party is over. In particular, after exploring/using the CLAS and the primitives it may contain to generate a part of an image, the graphics system may need to return back up the AS tree to explore other, not-yet-explored portions of the AS tree. A return up the AS tree needs to follow the same traversal path used to get to the AS or proper traversal of the AS will “break”. The graphics system will not be able to systematically explore yet-to-be-analyzed portions of the AS if it “forgets” the AS tree path it used to get to the CLAS.

This might seem a simple matter; why not store a “trail of breadcrumbs” the graphics system has used to depthwise traverse the AS tree and use these “breadcrumbs” to follow the reverse path. Graphics hardware has indeed conventionally used a “stack” memory structure to do exactly that. The system can “push” an entry onto the stack during a downward traversal of the AS tree, and “pop” that same entry off the stack during the reverse or upward traversal to recover the continuation address to resume AS tree traversal. The challenge comes with scalability. ASes can comprise literally millions of nodes, and traversal paths through the AS tree can encompass an arbitrary number of nodes. It may be impossible (or at least highly costly) to build a stack deep enough to store a complete traversal path.

Instead, many modern graphics hardware implementations have a short stack (e.g., 4 or 6 entries long) and constantly overwrite the stack with new entries. Such a “short stack” thus maintains “breadcrumbs” for the last few traversal steps, but there is a risk that birds can (figuratively speaking) eat the breadcrumbs that were previously saved on the stack. The stack can be counted on to retrace a few steps back, but no more (as if a caver's guideline has broken and the caver becomes lost in the cave without any way to get back to the entrance). In particular, CLASes of arbitrary complexity can thus cause the hardware to overwrite the short stack and thereby lose the indicator of the node that called the CLAS. It seems some other mechanism should be provided for reverse traversal through an arbitrary number of AS nodes.

To provide for such concerns, conventional ASes equip each complet with a pointer to its parent complet. The parent complet in turn has a pointer to its parent complet, and so on - sort of like tracing genealogy back any number of generations. The graphics hardware can thus retrace the traversal path from the AS itself. This works perfectly well when each parent complet has only one child complet.

But as soon as a CLAS can have more than one parent complet, the connections break down. Anyone who has actually traced their genealogy will immediately see the problem. Suppose now each complet has two parents rather than one—such as can happen when a CLAS is shared by two different BLAS parent nodes. In genealogy, since each parent has two parents, the number of backward paths increase geometrically. This leads to every one of us having more than a thousand (1024) 10^{th} great-grandparents.

It would be possible to support say two parents by storing extra pointers, but that solution is not scalable. Even going back a single generation, if a CLAS can have been parented by any one of say 1000 parent BLAS nodes, storing all those extra pointers becomes intractable. This is the situation when a CLAS can be called by multiple BLAS nodes—many thousands of BLAS nodes can potentially call the same CLAS cluster, e.g., to supply all the stone bricks for Hadrian's wall (or at least all the ones at the same LOD).

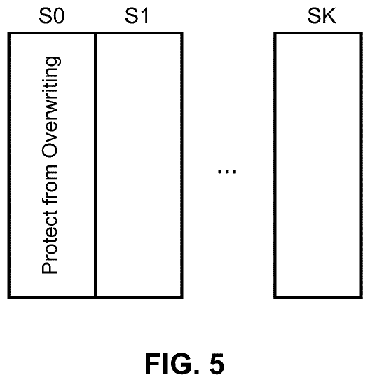

In example embodiments, the implementation solution can be simple: MPRC complets restrict the traversal stack size and stack limit to 1 fewer than its typical stack depth, sufficient to prevent overwriting the back-track entry on the stack from the CLAS cluster back to the BLAS node that called it. FIG. 5 shows an example where the traversal stack has K entries S0, S1, . . . SK and (only) one of the entries S0 (i.e., the one that stores the back track entry from the CLAS to the BLAS) is protected from being overwritten. Thus, the hardware can still use the traversal stack to help traverse the CLAS, but protects the stack entry storing the back pointer back to the node that called the CLAS from being overwritten by CLAS processing.

A simple way to do this is to prevent the CLAS traversal from pushing more than K-1 entries onto the stack and not allow any other complets or other structures beneath the complets whose entries are pushed that would require further stack pushes. That way, the entry that contains the back track continuation value will be protected from being overwritten, and the value it stores will be available for traversal backtracking/continuation.

One way to accomplish the above is to restrict the MPRC to be a single complet without multiple complets underneath it, i.e., only leaf nodes will be underneath it (i.e., no children complets other than triangle ranges) so it will not require multiple traversal backtracking levels. Such a restriction on the AS BVH means traversal will never descend down further to cause a stack overflow. The entire CLAS traversal is thus confined to the available stack entries S1, . . . , SK such that the stack entry S0 indicating the path back to the calling BLAS is never overwritten. When traversal of the CLAS completes, stack entry S0 supplies the continuation information that allows traversal to continue at the particular BLAS node that called the CLAS.

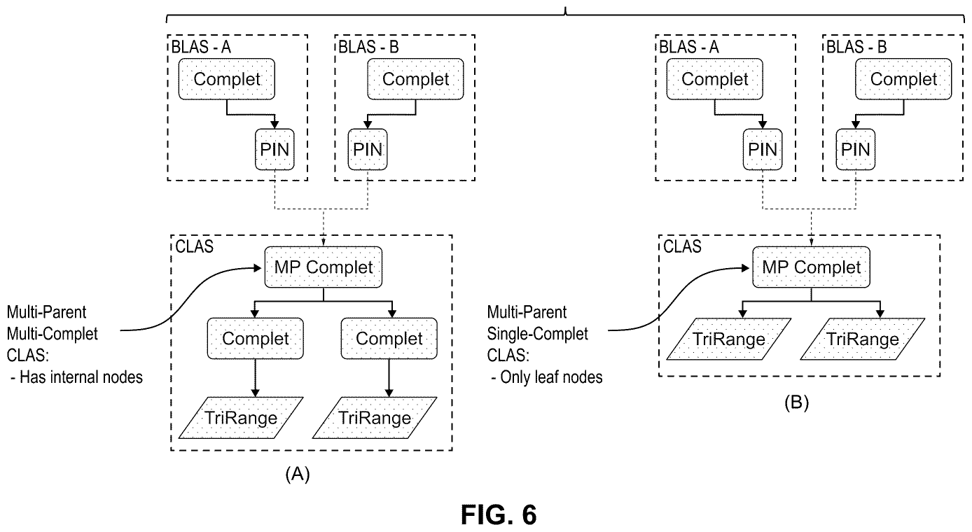

FIG. 6 illustrates the above restriction on the right-hand side (B) and contrasts it with a CLAS on the left-hand side (A) with no such restriction.

For the FIG. 6 right-hand side structure (“B”), when the parentLeafIdx indicates MPRC, the transveral engine simply reduces the physical stack size and stack limit by one, as described above.

Multi-complet support underneath the MPRC complet as shown on the left is possible, but is more complicated because multi-complets could push extra entries as traversal descends and cause a stack overwrite. For the FIG. 6 left-hand side structure (“A”), traversal control may involve locking an entry on the stack to protect it from being overwritten. See the following non-limiting example:
When Multi-Parent PINs are hit, TL sends lock information to SMU
When locking, SMU locks stack entries and sets new lock meta data to track
Meta data is new per-ray storage (area cost)
Meta data passed back-and-forth from traversal hardware to SM software-running core processor in variable complet entry stack space
Meta data indicating lock active is passed from SMU through to traversal hardware
When lock active, traversal hardware reduces the physical stack size and stack limit by 1 (e.g., 3 and 3)
When lock active, SMU stack updates from RCT require a read-modify-write of all meta data with appropriate shifts of the write entry positions to avoid clobbering locked entries
Stack pops require update of the lock meta data with potential unlocking when CLAS completes
Stack pointer updates modified to avoid accessing locked entries while lock is active.

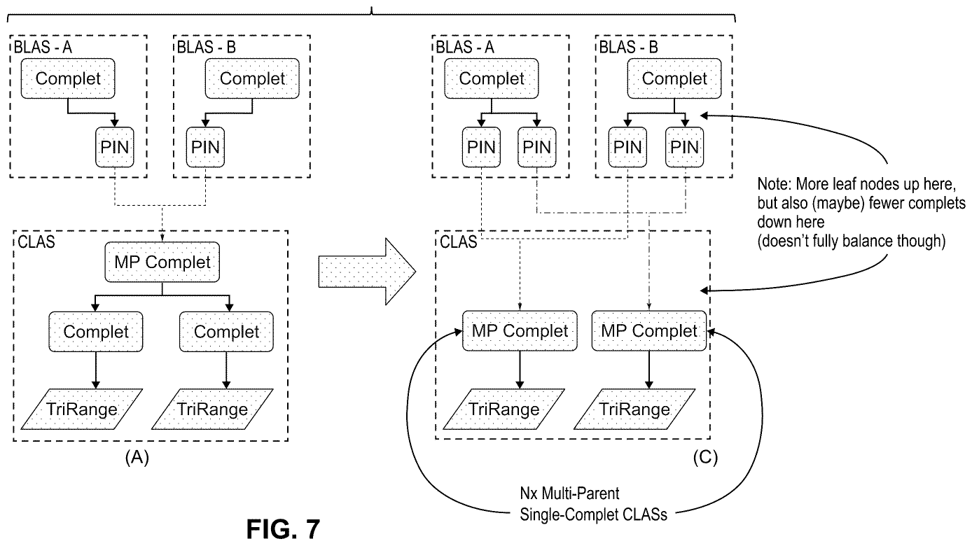

FIG. 7 addresses the issue of how to use the simpler, right-hand side AS topology that will not cause a stack overflow when the CLAS complexity does not all fit within a single MPRC complet. In that case, it is possible to break the CLAS into multiple smaller CLASes. The builder then points directly from the MPRC complets to the last level (primitive, leaf node complets) without any intermediate complets therebetween. This approach will increase the number of leaf nodes that are in the BLAS. For example, note that in the FIG. 7 example, the right-hand side has four PINs instead of two PINs. But in example embodiments, the size of a PIN is quite small, so memory overhead is not increased significantly.

FIG. 4B graph “E” shows an example of an AS that uses the multiple-parent technology that MPRC provides. As compared with FIG. 4B graph “D”, FIG. 4B graph “E” has an additional node labelled “X” that functions as an additional BLAS parent node for the CLAS clusters pointed to by PIN pointers PIN0, PIN1. In example embodiments, the PIN pointer mechanism is thus extended to allow a CLAS cluster to have multiple parents—thus relieving the legacy restriction that each child node has only a single pointer back to its single parent to allow reverse traversal back up the BVH hierarchy. Using MPRC, a CLAS node can point back to multiple parent nodes, and reverse traversal can return to the particular parent node that called the CLAS.

This MPRC mechanism enables the system to treat the entire BLAS and all the CLAS underneath it as if it were a singular object as it existed in a legacy system. Legacy systems would generally traverse the entire BLAS. For example, suppose there is a traversal of the AS tree or graph downward from node A to node B to node C shown in FIG. 4B graph “E”. The system would then use node C's PIN0 to get to node D which is the head node of CLAS(D). When the system is finished traversing CLAS(D), it may then need to do a reverse traversal upwards in the tree, e.g., to access node J. But depending on the system, the information needed to reverse traverse the tree to node J may no longer be available (e.g., due to a short stack overrun). The system instead should be able to learn this information by reverse-traversing the AS. But with PIN0 able to be used by multiple parent nodes (each of node C and node X in the example shown), the system has no idea where the traversal came from—did it reach CLAS(D) from node C or from node X? MPRC provides something analogous to a “breadcrumb” or “guide line” enabling reverse traversal to return to the BLAS that initiated the call to a CLAS so the traversal hardware can properly find its way back up the AS tree to the BLAS that called it.

In some examples, reuse of a CLAS across multiple BLASs involves locating the underlying geometry at the same object-space location since there is no additional transformation happening. This may seem rare but can be common with BLAS specialization. BLAS specialization occurs when instances of the BLAS have small differences. Because they are not identical, in some embodiments the BLAS is replicated and modified. But as much of the BLAS may be common between the two, reusing those portions rather than duplicating them can save on storage overhead imposed by the BLAS specialization.

Meanwhile, FIG. 4A graph “C” illustrates how MPRC can be used independently of PIN—in this case in combination with EPC. In this case, the explicit pointers are in the complet itself (e.g., node C and node X) rather than using the indirection of a PIN. While the traversal lines appear to be clearer in this example, node C and node X can now point only to a reduced number of child nodes because of the extra space taken up by explicit addresses as opposed to implicit addresses. A potential disadvantage is that in some embodiments this may force a reduced width of the entire tree (e.g., a 6-wide tree as opposed to a 12-wide tree). BVHs aren't necessarily balanced (and usually aren't) so inclusion of instances higher in the tree essentially means the entire tree becomes reduced width. Memory footprint for N children is doubled plus additional costs as described above, and performance may suffer slightly due to the reduced width tree. Using PIN along with MPRC meanwhile introduces a new (e.g., 64 B) structure but can store more (e.g., 12) instances in that structure. Furthermore, the memory footprint for the (e.g., 12) children is 128 B+64 B with no additional imposed cost higher in the tree and less performance impact than the half-width tree.

### Non-Limiting Traversal Examples

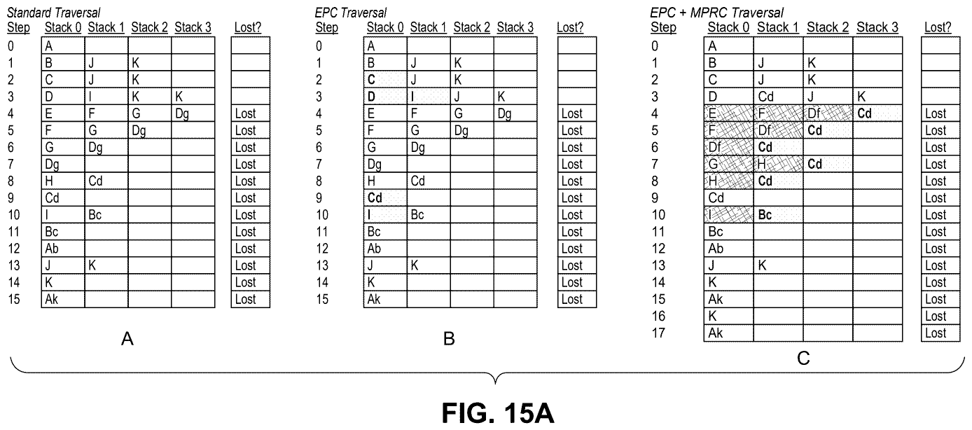

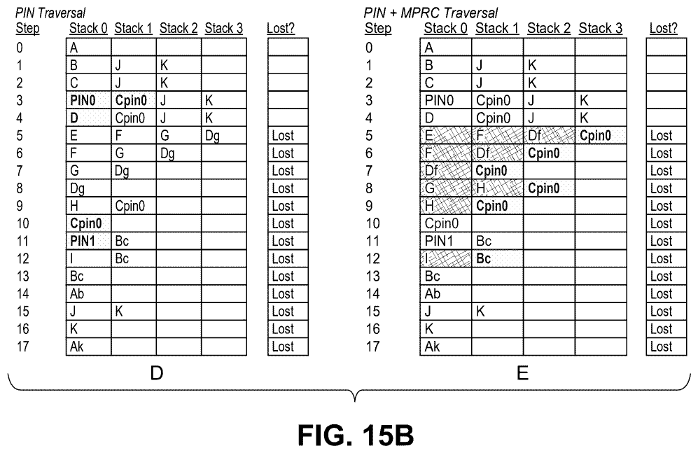

The following traversal examples show the different behaviors and the effects on the stack of the different AS structures shown in FIG. 4A/4B. The labels “A”, “B”, “C”, “D”, “E” of FIG. 15A/15B correspond to the labels “A”, “B”, “C”, “D”, “E” of FIG. 4A/4B.

### Example Traversal: Explicit Pointer Complets

As described above, FIG. 4A graph “B” shows a standard BVH converted to use explicit pointer complets and then explicit pointer complets with multi-parent root complets (graph “C”). The multi-parent aspect comes from node X belonging to a separate BVH and pointing directly to the D and I nodes that are the root complets of the CLAS. In the example corresponding traversal sequences shown in FIG. 15A, only intersected nodes are shown.

Note that EPC traversal (“B” traversal log of FIG. 15A) looks identical to standard traversal (“A”) even though some steps have an explicit indirection instead of implicit. When adding in MPRC (“C” traversal log of FIG. 15A), the stack size reduction causes a few more steps because of added continuation. E.g., when traversing the sub-tree under D, we must keep the Cd continuation complet entry as D would not otherwise know whether to return to C or X. In fact, D has no knowledge of either C or X whereas in the non-MPRC version D would point explicitly to C. By restricting the stack size and limit to 3 and only having a single complet allowed in the D sub-tree/CLAS, we can guarantee that during the traversal of the D CLAS nothing would overwrite the continuation back into either the C or X trees.

### Example Traversal: Pseudo Instance Nodes

As discussed above, FIG. 15B shows the same FIG. 15A standard BVH scene as above converted to use pseudo instance nodes (“D”) and then pseudo-instance nodes with multi-parent root complets (“E”). The multi-parent aspect comes from node X belonging to a separate BVH. Here it is shown that X is sharing the same PIN, but X could also have its own PIN independently pointing to D and I.

In this example, only intersected nodes are shown. With PIN traversal (“D” traversal log of FIG. 15B) there are additional steps to translate from the PIN stack entry to the complet underneath.

Like with explicit pointers, when adding MPRC to PIN (“E” traversal log of FIG. 15B), the CLAS traversal is restricted further as discussed above such that when traversing D, the continuation Cpin0 is ensured to be on the stack.

### Instance Grouping

The complexity of many scenes is such that there may be many millions of BLASes in the AS over which the TLASes are built. Specifically, the TLAS build grows with the number of instances in a scene. This can cause timeliness problems for real time or close to real time applications.

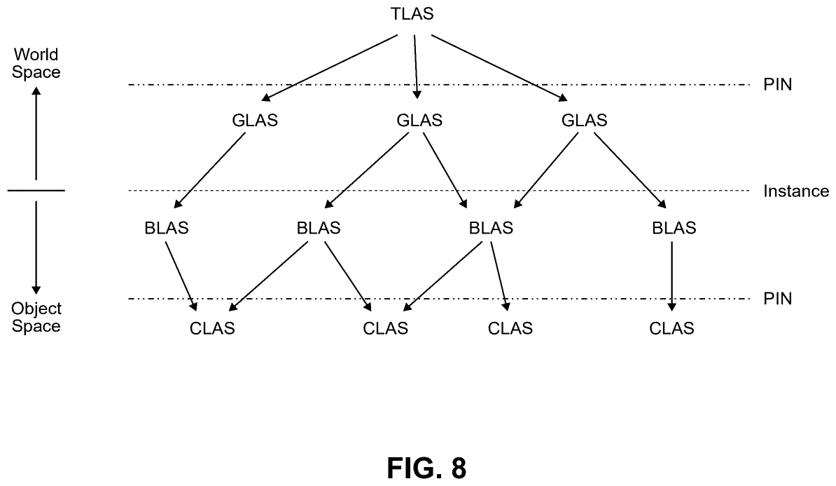

Example embodiments reduce this problem by introducing instance groups. Instance grouping involves grouping instances into subsets—for example, all the instances in one room of a scene could be grouped into a first instance group acceleration structure, all the instances in another room of the scene could be grouped into a second instance group acceleration structure, and so on. The builder then constructs a TLAS on top of each instance group. For purposes of clarification, we can now rename such TLASes built on top of an instance group a Group TLAS or “GLAS.” Thus, the builder can construct a first group TLAS (“GLAS”) on top of the first instance group, it can construct a second group TLAS (“GLAS”) on top of the second instance group, and so on. Furthermore, the builder's construction of the various such GLASes can be parallelized, e.g., performed on a multi-core processing system such as a CPU or GPU. The builder can then construct one final TLAS at the very top of the AS above all of the GLASes, as shown in FIG. 8.

In an example embodiment, the PIN can be used at any level of the AS including the top level. Thus, a PIN can be used at the top of the AS between the root TLAS and the GLASes to swap different GLASes in and out. As shown in FIG. 8, the AS structure now has hierarchical linkages such as

TLAS->GLASes->BLASes->CLASes,
where the standard instance transforms are implemented between the TLAS and BLAS transition, and PIN indirection may be used between the TLAS and GLASes. From a DXR perspective, the resulting structure is still just two levels of instancing even though there is an additional level of lightweight non-transforming instancing implemented by the PINs.

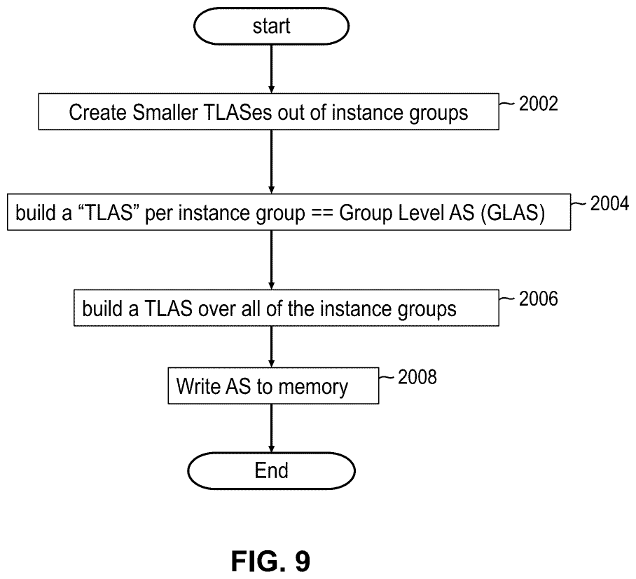

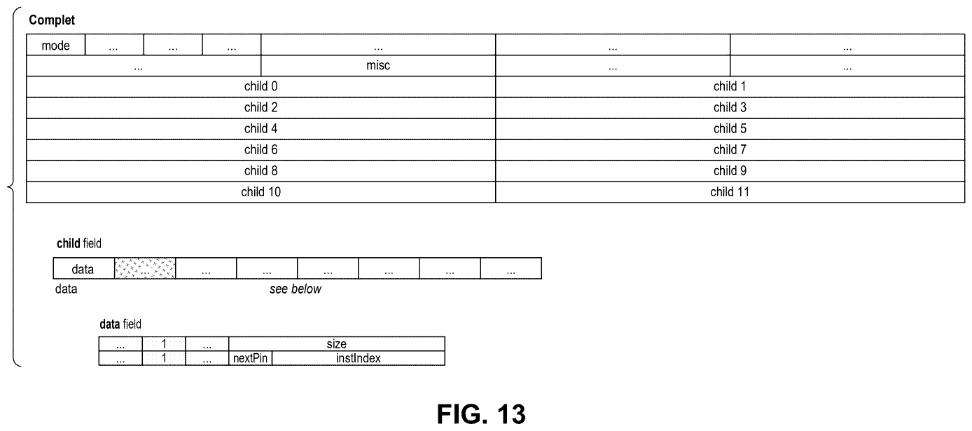

In example embodiments, a GLAS cannot be reused multiple times like an instance since there is no transform to place an instance somewhere else, but it still is valuable for breaking the build into smaller chunks, e.g., for more build parallelism. This can be done for example by:
creating (in parallel) smaller TLASs out of instance groups (FIG. 9 block 2010);
building (in parallel) a “TLAS” per instance group==Group Level AS (GLAS) (FIG. 13 block 2004);
building a common TLAS over all of the instance groups (FIG. 9 block 2006);
write the built AS to memory (FIG. 9 block 2008) (in one embodiment, even though the GLASes are all linked to the same complet, the GLASes now do not have to be contiguous in memory because of the indirection the PINs provide).

In such case, leaf nodes of the TLAS complet are the PINs that point to each GLAS (see FIG. 8).

While the GLASes cannot in this example be reused across the TLAS, the CLASes can still be reused across the BLASes as discussed above. This is because while the BLASes (and thus the CLASes) exist in the same object spaces, due to the instancing transform a first BLASes world space location will be different than a second BLAS world space location, and so on. This implies that the CLASes can be reused across the BLASes (because they are all in the same object space)

One could also however imagine having multiple top level TLASes across which the GLASes can be reused since the TLASes and GLASes are both in world space and transitioning between them does not use a coordinate transformation.

### Example Builder

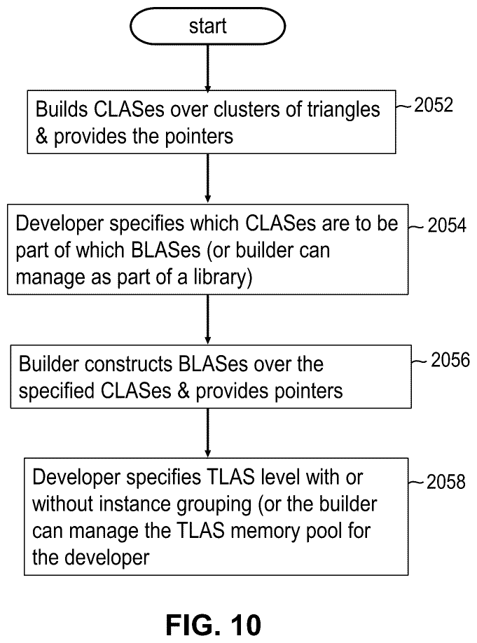

In example embodiments, an AS builder may comprise a computer including at least one CPU and at least one GPU that executes software instructions stored in at least one non-transitory memory. As noted above, the execution can be parallelized such that several or many parts of the AS can be built concurrently. FIG. 10 shows an example builder process that begins with supplying the builder with clusters of primitives such as triangles (block 2052). The builder builds CLASes over such triangle clusters, and generates associated pointers for the built CLASes in memory (block 2052). A specification (which can be supplied by a developer or by the builder itself) is then provided that specifies which CLASes are to be part of which BLASes (block 2054). The builder uses this specification to construct BLASes over the specified CLASes and generates pointers (block 2056). The developer then provides a specification of TLAS level with or without instance grouping (or the builder can manage the TLAS memory pool for the developer (block 2058)). The builder constructs the TLAS level over the BLAS level, and stores the now instanced AS to a nontransitory memory for access by a graphics system to use to generate visualizations. The builder can if desired perform the FIG. 10 flowchart many times a second in real time to update the portions of the AS in response to real time events such as user input, change in viewpoint of the scene, etc.

### Example AS Encoding

The following non-limiting data encoding examples implement the above instance node features in the context of data structures consumed by a legacy NVIDIA AS for a hardware ray tracer (see e.g., developer.nvidia.com/rtx/raytracing/dxr/dx12-raytracing-tutorial-part-1 #: ˜:text=The%20acceleration%20structures%20store%20the, top%2Dlevel%20(TLAS);. developer.nvidia.com/blog/reducing-acceleration-structure-memory-with-nvidia-rtxmu/;RTCMU Version 1.4 at github.com/NVIDIAGameWorks/RTXMU.

### Pseudo Instance Nodes: Example Encoding

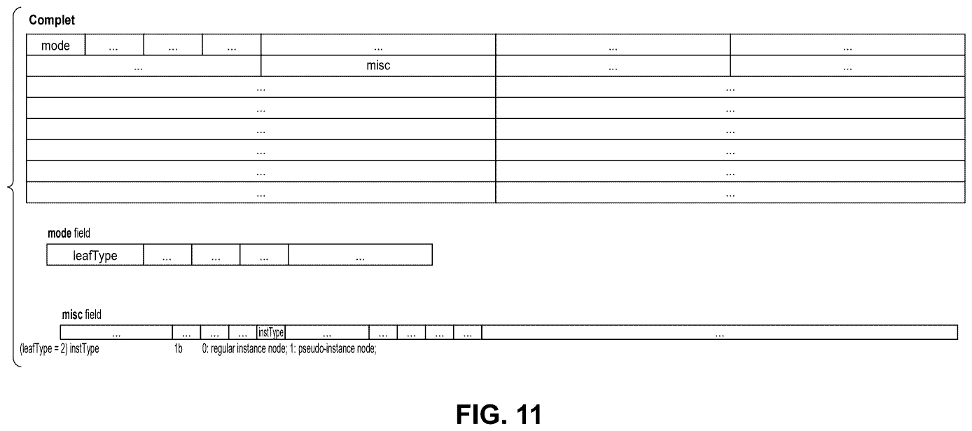

FIG. 11 shows an example pseudo-instance node that uses the same instance node leaf type in the complet but adds a 1-bit instance type field to the complet's misc field to indicate that the leaves of the complet are pseudo-instance nodes instead of regular instance nodes. In one embodiment, this field is only present when the leafType field in the complet's mode field indicates an instance node. In example embodiments, a BLAS complet can use its explicit address to point to a PIN, and the PIN then supplies a multiplicity of absolute or relative addresses to in turn point to a multiplicity of CLASes. It is also possible for a BLAS complet to point to multiple PINs using the normal explicit/implicit addressing. Even though the PINs themselves would thus be stored in sequence contiguously in memory, the PINs can now point to respective CLASes stored anywhere in the memory address space.

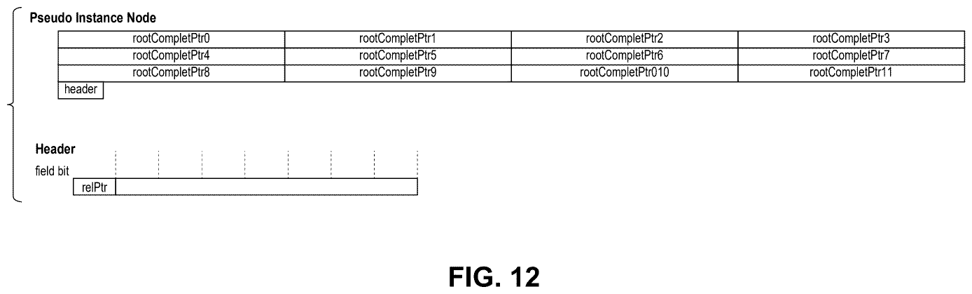

FIG. 12 shows an example pseudo-instance node itself. In one example, the pseudo-instance node is a 64-byte node—same as a single-wide instance node—with up to 12 indexed pseudo-instance root complet pointers (which may be either absolute or signed relative in one embodiment) representing 12 PINs. In one embodiment, a pseudo-instance node complet header indicates whether the pointers are absolute or relative (e.g., to the pseudo-instance node address). The difference is simply how the address is constructed: “AddrA” or “AddrA+AddrB”. The absolute pointers are generally used when the underlying CLAS location is independent of the location of the PIN in memory. However, if the CLAS and PIN are constructed as a conceptual single region in memory, then relative addressing can be used. That enables that memory region to be moved elsewhere, if desired, without having to update the pointers within the PIN. If a PIN with relative addressing is moved without also moving the CLASes, then the pointers need to be recalculated and absolute addressing would have been a better choice. If the CLASes are moved while the PIN is kept in place, the addresses have to be reset in both cases (relative or absolute).

As indicated above, there are no references or contents for transforms such as transformation matrices because the function of this pseudo-instance node is to select/point to a CLAS without specifying an additional instance transform. This therefore enables the pseudo-instance node to specify a multiplicity of pointers while keeping memory footprint small.

To properly select from among the 12 root complet pointers, the per-child data field is modified as shown in FIG. 13 to include an index within the PIN with an additional “child” data field to advance to the next contiguous PIN for the next child in the complet. In one embodiment, a size field can indicate the number of instance transform structures are allocated (this can be zero); a “nextPin” field if set can advance a pointer to a next pseudo-instance node, and an instanceindex (“instIndex”) field may comprise an index of the instance within the multi-instance node.

FIG. 15 (top) shows an example instance type (e.g., instType can select between a regular instance node and a pseudo-instance node) stored in the TTU stack entry along with an instance index (if instType indicates a pseudo-instance node, the instindex field comprises an index of the instance within the multi-instance node).

An example stack return format is shown on the bottom of FIG. 15. When returning to SM (the s bit being set in the stack entry), the instance type and instance index are both returned as well in the HitType_InstanceNode. Stack returns to SM can either be forced or a result of ray ops.

### MPRC Example Encoding

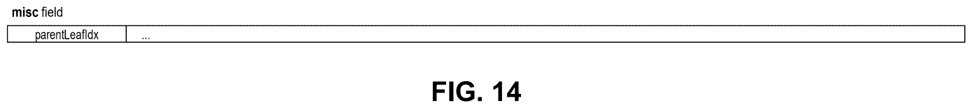

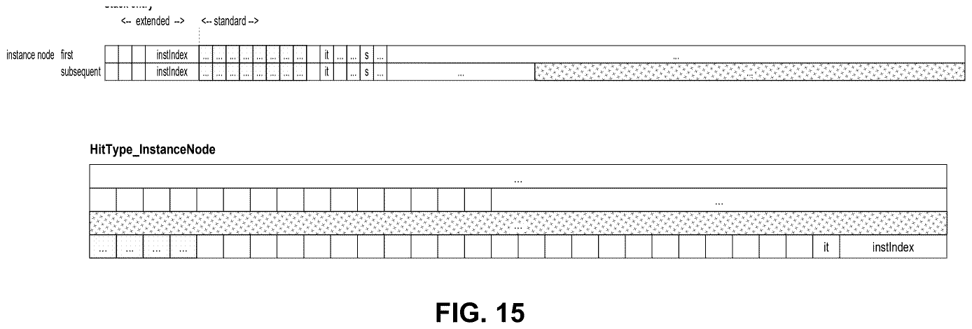

FIG. 14 shows example encoding of the parent leaf index field within a FIG. 11 complet's “misc” field used to indicate whether a complet is a root or not. In one embodiment, MPRC uses a spare encoding in that “parentLeafIdx” (parent leaf index) field to indicate that it is a root complet of the MPRC type, i.e., multi-parent/limited stack root.

### Example: Ray Tracing

A ray tracer performs a test of each ray against a wide range of bounding volumes, and can cull any bounding volumes that don't intersect with that ray. Starting at a BVH root node that bounds everything in the scene, the traversal co-processor tests each ray against smaller (potentially overlapping) child bounding volumes which in turn bound the descendent branches of the BVH. The ray follows the child pointers for the bounding volumes the ray hits to other nodes until the leaves or terminal nodes (volumes) of the BVH are reached. If the item comprises primitives, the ray tracer tests rays against the primitives to determine which (if any) object surfaces the rays intersect and which object surfaces are visible along the ray.

The ray-primitive test can provide additional information about primitives the ray intersects that can be used to determine the material properties of the surface required for shading and visualization. Recursive traversal through the acceleration data structure enables the traversal co-processor to discover all object primitives the ray intersects, or the closest (from the perspective of the viewpoint) primitive the ray intersects (which in some cases is the only primitive that is visible from the viewpoint along the ray). See e.g., U.S. Pat. Nos. 10,580,196; 12,073,504.

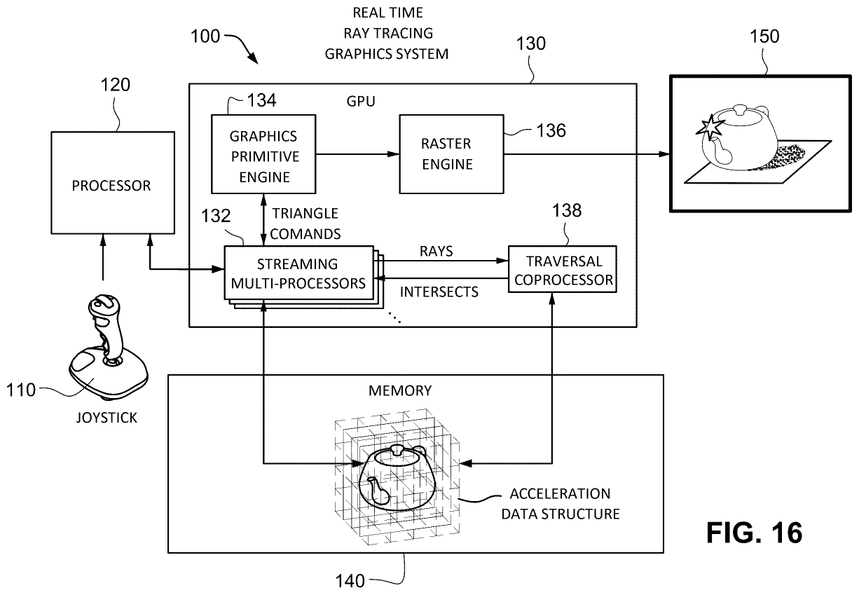

The following example processing is performed by a slightly modified “TTU” or “tree traversal unit” hardware and associated ray tracing computer graphics system as described in for example U.S. Pat. No. 12,154,214B2; US20240095995A1; U.S. Pat. Nos. 11,508,112B2; 11,450,057B2; 11,380,041B2; 11,373,358B2; 11,302,056 B2; 11,295,508 B2; 11,282,261B2; 11,157,414B2; 11,138,009B2; 10,885,698B2; 10,867,429B2; 10,825,230B2; 10,810,785B2; 10,740,952B2; 10,580,196B1. The descriptions of each of these prior filed patents and patent applications are expressly incorporated herein by reference. See a further description of an example tree traversal unit (hardware) provided below and shown in FIG. 16 and following for further background, understanding and completeness.

### Pseudo Index Node: Example Processing

Complets are processed in the Ray-Complet Test (RCT) unit.

When a PIN leaf node is hit in a complet, TL will craft an appropriate instance node stack entry with the instance type set to PIN, a correct instance index, and the PIN pointer. When a complet with PIN leaf nodes is processed in TL, then the stack limit will be treated as 2 instead of whatever programmed value is specified. The implication is that only a single PIN will be pushed onto the stack at any one time, though any number of complets may be pushed. This is a simplification to obey one primary rule of the short stack: complets cannot be placed in front of leaves.

(Technically, we could relax this rule as a PIN stack entry is equivalent to a complet in that it can be converted directly without expanding the stack. However, this complicates various logic and the addition of multi-parent root complets will require a stack-limit of 2 as well. For these reasons, we leave the stack-limit at “2” independent of the target root type.)

SMU will process an instance node the same as conventionally, but also pass along the instance type and index through to RTT. Within RTT, the PIN flows through like a regular instance node. However, the PIN indicator means there is no transform of the ray, no ray flag modifications, and no recording of instance information. Instead, a PIN processed in RTT simply decodes the root complet pointer address at the specified index within the PIN and passes that through IMU to SMU where a new complet stack entry is crafted to replace the PIN stack entry.

The root complet pointer may be either absolute or relative. If relative, it is relative from a 128-byte aligned version of the PIN address. (Since in one embodiment PIN are 64-byte in size and can thus be offset from 128-byte alignment while complets are always 128 B aligned, we use the 128-byte aligned version of the PIN address for relative complet pointers.)

If the AS under the PIN is not shared (i.e., not a multi-parent root complet), then it has a single parent. The “root” complet of the AS will not be tagged as a root, but rather will use the parent pointer and index of its associated PIN. In that way, traversal can continue from that complet back to the parent complet as usual.

If the AS under the PIN is shared (i.e., has multiple parents and is thus a multi-parent root complet), then it will be tagged as a special kind of root complet as described in the multi-parent root complet section.

Once that new “root” complet stack entry is in the stack (whether multi-parent or not), the processing of the PIN is done and all traversal completes as normal as if the PIN had never occurred.

Example Variation: Specifying multi-parent in the complet PIN with multi-parent multi-complet uses a multi-bit instance type in the complet encoding for example between (a) regular instance node, (b) pseudo-instance node, or (c) multi-parent pseudo-instance node.

By specifying whether the underlying AS is multi-parent or not can allow the complet to not need a stack-limit of 2 always.

### MPRC Example Processing

When a multi-parent root complet is processed in TL, the stack size and the stack limit are each reduced by 1.

E.g., with a stack size of say 6 and a stack limit also of say 6, then the MPRC will be processed with both a stack size of 5 and a stack limit of 5.

As with all root complets, the multi-parent root complet shall be treated as a root complet for traversal purposes. That is, when the lost bit is set, the parent pointer is not used and no parent continuation would be pushed.

The stack however may not be empty and the remaining contents of the stack can be used to continue traversal.

### Example Legacy Hardware Implementation

The above description modifies the below-described hardware ray tracer implementation in one example embodiment.

### Example System Block Diagram

FIG. 16 illustrates an example real time ray interactive tracing graphics system 100 for generating images using three dimensional (3D) data of a scene or object(s) including the acceleration data structure constructed as described above.

System 100 includes an input device 110, a processor(s) 120, a graphics processing unit(s) (GPU(s)) 130, memory 140, and a display(s) 150. The system shown in FIG. 16 can take on any form factor including but not limited to a personal computer, a smart phone or other smart device, a video game system, a wearable virtual or augmented reality system, a cloud-based computing system, a vehicle-mounted graphics system, a system-on-a-chip (SoC), etc.

The processor 120 may be a multicore central processing unit (CPU) operable to execute an application in real time interactive response to input device 110, the output of which includes images for display on display 150. Display 150 may be any kind of display such as a stationary display, a head mounted display such as display glasses or goggles, other types of wearable displays, a handheld display, a vehicle mounted display, etc. For example, the processor 120 may execute an application based on inputs received from the input device 110 (e.g., a joystick, an inertial sensor, an ambient light sensor, etc.) and instruct the GPU 130 to generate images showing application progress for display on the display 150.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server or in a data center and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

Furthermore, images generated applying one or more of the techniques disclosed herein may be used to train, test, or certify deep neural networks (DNNs) used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

Based on execution of the application on processor 120, the processor may issue instructions for the GPU 130 to generate images using 3D data stored in memory 140. The GPU 130 includes specialized hardware for accelerating the generation of images in real time. For example, the GPU 130 is able to process information for millions or billions of graphics primitives (polygons) in real time due to the GPU's ability to perform repetitive and highly-parallel specialized computing tasks such as polygon scan conversion much faster than conventional software-driven CPUs. For example, unlike the processor 120, which may have multiple cores with lots of cache memory that can handle a few software threads at a time, the GPU 130 may include hundreds or thousands of processing cores or “streaming multiprocessors” (SMs) 132 running in parallel.

In one example embodiment, the GPU 130 includes a plurality of programmable high performance processors that can be referred to as “streaming multiprocessors” (“SMs”) 132, and a hardware-based graphics pipeline including a graphics primitive engine 134 and a raster engine 136. These components of the GPU 130 are configured to perform real-time image rendering using a technique called “scan conversion rasterization” to display three-dimensional scenes on a two-dimensional display 150. In rasterization, geometric building blocks (e.g., points, lines, triangles, quads, meshes, etc.) of a 3D scene are mapped to pixels of the display (often via a frame buffer memory).

The GPU 130 converts the geometric building blocks (i.e., polygon primitives such as triangles) of the AS into pixels of the 2D image and assigns an initial color value for each pixel. The graphics pipeline may apply shading, transparency, texture and/or color effects to portions of the image by defining or adjusting the color values of the pixels. The final pixel values may be anti-aliased, filtered and provided to the display 150 for display. Many software and hardware advances over the years have improved subjective image quality using rasterization techniques at frame rates needed for real-time graphics (i.e., 30 to 60 frames per second) at high display resolutions such as 7680×4320 pixels or more on one or multiple displays 150.

To enable the GPU 130 to perform ray tracing in real time in an efficient manner, the GPU provides one or more “TTUs” 138 coupled to one or more SMs 132. The TTU 138 includes hardware components configured to perform (or accelerate) operations commonly utilized in ray tracing algorithms. A goal of the TTU 138 is to accelerate operations used in ray tracing to such an extent that it brings the power of ray tracing to real-time graphics application (e.g., games), enabling high-quality shadows, reflections, and global illumination. Results produced by the TTU 138 may be used together with or as an alternative to other graphics related operations performed in the GPU 130.

More specifically, SMs 132 and the TTU 138 may cooperate to cast rays into a 3D model and determine whether and where that ray intersects the model's geometry. Ray tracing directly simulates light traveling through a virtual environment or scene. The results of the ray intersections together with surface texture, viewing direction, and/or lighting conditions are used to determine pixel color values. Ray tracing performed by SMs 132 working with TTU 138 allows for computer-generated images to capture shadows, reflections, and refractions in ways that can be indistinguishable from photographs or video of the real world. Since ray tracing techniques are even more computationally intensive than rasterization due in part to the large number of rays that need to be traced, the TTU 138 is capable of accelerating in hardware certain of the more computationally-intensive aspects of that process.

Given a BVH constructed as described above, the TTU 138 performs a tree search where each node in the tree visited by the ray has a bounding volume for each descendent branch or leaf, and the ray only visits the descendent branches or leaves whose corresponding bound volume it intersects. In this way, TTU 138 explicitly tests only a small number of primitives for intersection, namely those that reside in leaf nodes intersected by the ray. In the example non-limiting embodiments, the TTU 138 accelerates both tree traversal (including the ray-volume tests) and ray-primitive tests. As part of traversal, it can also handle instance transforms, transforming a ray from world-space coordinates into the coordinate system of an instanced mesh. In the example non-limiting embodiments, the TTU 138 does all of this in MIMD fashion, meaning that rays are handled independently once inside the TTU.

In the example non-limiting embodiments, the TTU 138 operates as a servant (coprocessor) to the SMs (streaming multiprocessors) 132. In other words, the TTU 138 in example non-limiting embodiments does not operate independently, but instead follows the commands of the SMs 132 to perform certain computationally-intensive ray tracing related tasks much more efficiently than the SMs 132 could perform themselves. In other embodiments or architectures, the TTU 138 could have more or less autonomy.

In the examples shown, the TTU 138 receives commands via SM 132 instructions and writes results back to an SM register file. For many common use cases (e.g., opaque triangles with at most one level of instancing), the TTU 138 can service the ray tracing query without further interaction with the SM 132. More complicated queries (e.g., involving alpha-tested triangles, primitives other than triangles, or multiple levels of instancing) may require multiple round trips (although the technology herein reduces the need for such “round trips” for certain kinds of geometry by providing the TTU 138 with enhanced capabilities to autonomously perform ray-bounding-volume intersection testing without the need to ask the calling SM for help). In addition to tracing rays, the TTU 138 is capable of performing more general spatial queries where an AABB or the extruded volume between two AABBs (which we call a “beam”) takes the place of the ray. Thus, while the TTU 138 is especially adapted to accelerate ray tracing related tasks, it can also be used to perform tasks other than ray tracing.

The TTU 138 thus autonomously performs a test of each ray against a wide range of bounding volumes, and can cull any bounding volumes that don't intersect with that ray. Starting at a root node that bounds everything in the scene (or in some cases, starting at an alternate root as discussed above), the traversal co-processor tests each ray against smaller (potentially overlapping) child bounding volumes which in turn bound the descendent branches of the BVH. The ray follows the child pointers for the bounding volumes the ray hits to other nodes until the leaves or terminal nodes (volumes) of the BVH are reached.

Once the TTU 138 traverses the acceleration data structure to reach a terminal or “leaf” node (which may be represented by one or multiple bounding volumes) that intersects the ray and contains a geometric primitive, it performs an accelerated ray-primitive intersection test to determine whether the ray intersects that primitive (and thus the object surface that primitive defines). The ray-primitive test can provide additional information about primitives the ray intersects that can be used to determine the material properties of the surface required for shading and visualization. Recursive traversal through the acceleration data structure enables the traversal co-processor to discover all object primitives the ray intersects, or the closest (from the perspective of the viewpoint) primitive the ray intersects (which in some cases is the only primitive that is visible from the viewpoint along the ray). See e.g., Lefrancois et al, NVIDIA Vulkan Ray Tracing Tutorial, December 2019, developer.nvidia.com/rtx/raytracing/vkray

As mentioned above, the TTU 138 also accelerates the transform of each ray from world space into object space to obtain finer and finer bounding box encapsulations of the primitives and reduce the duplication of those primitives across the scene. As described above, objects replicated many times in the scene at different positions, orientations and scales can be represented in the scene as instance nodes which associate a bounding box and leaf node in the world space BVH with a transformation that can be applied to the world-space ray to transform it into an object coordinate space, and a pointer to an object-space BVH, as described above. This avoids replicating the object space BVH data multiple times in world space, saving memory and associated memory accesses. The instance transform increases efficiency by transforming the ray into object space instead of requiring the geometry or the bounding volume hierarchy to be transformed into world (ray) space and is also compatible with additional, conventional rasterization processes that graphics processing performs to visualize the primitives.

### Example Ray Tracing Processes

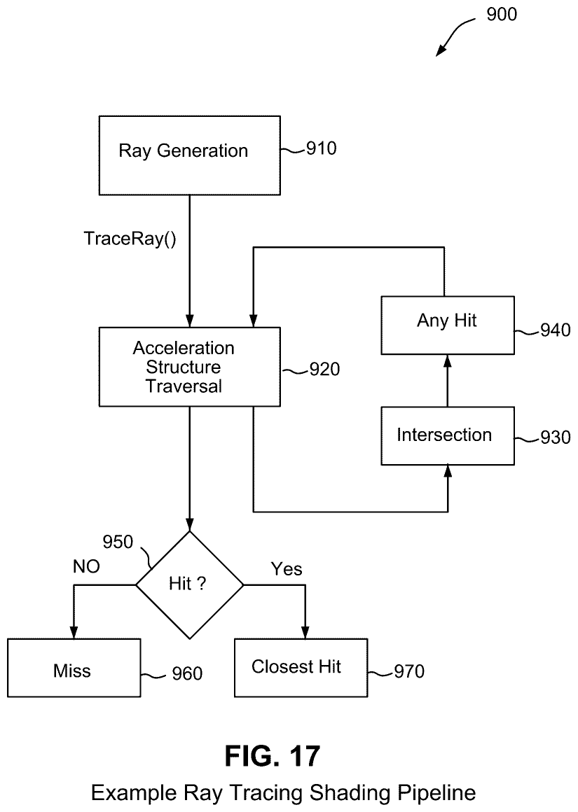

FIG. 17 shows an exemplary ray tracing shading pipeline 900 that may be performed by SM 132 and accelerated by TTU 138. The ray tracing shading pipeline 900 starts by an SM 132 invoking ray generation 910 and issuing a corresponding ray tracing request to the TTU 138. The ray tracing request identifies a single ray cast into the scene and asks the TTU 138 to search for intersections with an acceleration data structure the SM 132 also specifies. The TTU 138 traverses (FIG. 17 block 920) the acceleration data structure to determine intersections or potential intersections between the ray and the volumetric subdivisions and associated triangles the acceleration data structure represents. Potential intersections can be identified by finding bounding volumes in the acceleration data structure that are intersected by the ray. Descendants of non-intersected bounding volumes need not be examined.

For triangles within intersected bounding volumes, the TTU 138 ray-primitive test block 720 performs an intersection 930 process to determine whether the ray intersects the primitives. The TTU 138 returns intersection information to the SM 132, which may perform an “any hit” shading operation 940 in response to the intersection determination. For example, the SM 132 may perform (or have other hardware perform) a texture lookup for an intersected primitive and decide based on the appropriate texel's value how to shade a pixel visualizing the ray. The SM 132 keeps track of such results since the TTU 138 may return multiple intersections with different geometry in the scene in arbitrary order.

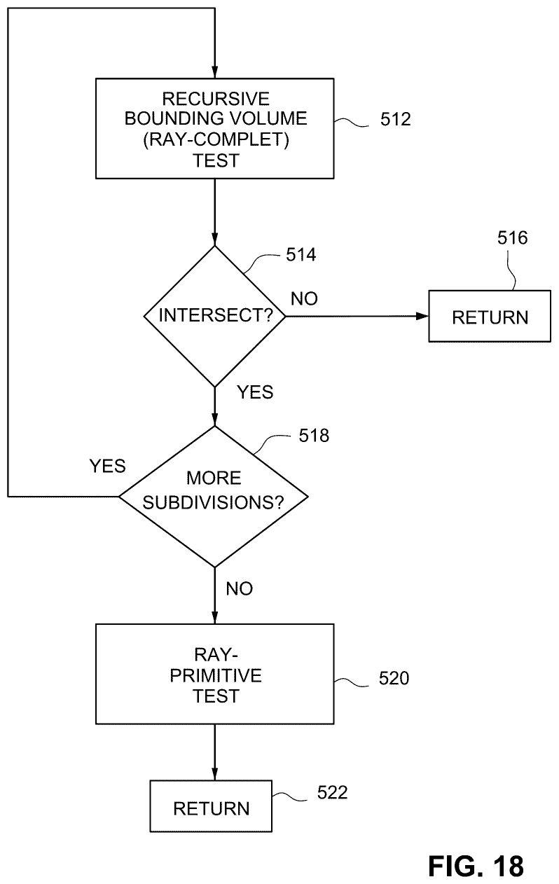

FIG. 18 is a flowchart summarizing example ray tracing operations the TTU 138 performs as described above in cooperation with SM(s) 132. The FIG. 18 operations are performed by TTU 138 in cooperation with its interaction with an SM 132. The TTU 138 may thus receive the identification of a ray from the SM 132 and traversal state enumerating one or more nodes in one or more BVH's that the ray must traverse. The TTU 138 determines which bounding volumes of a BVH data structure the ray intersects (the “ray-complet” test 512). The TTU 138 can also subsequently determine whether the ray intersects one or more primitives in the intersected bounding volumes and which triangles are intersected (the “ray-primitive test” 520)—or the SM 132 can perform this test in software if it is too complicated for the TTU to perform itself. In example non-limiting embodiments, complets specify root or interior nodes (i.e., volumes) of the bounding volume hierarchy with children that are other complets or leaf nodes of a single type per complet.

First, the TTU 138 inspects the traversal state of the ray. If a stack the TTU 138 maintains for the ray is empty, then traversal is complete. If there is an entry on the top of the stack, the traversal co-processor 138 issues a request to the memory subsystem to retrieve that node. The traversal co-processor 138 then performs a bounding box test 512 to determine if a bounding volume of a BVH data structure is intersected by a particular ray the SM 132 specifies (step 512, 514). If the bounding box test determines that the bounding volume is not intersected by the ray (“No” in step 514), then there is no need to perform any further testing for visualization and the TTU 138 can return this result to the requesting SM 132. This is because if a ray misses a bounding volume (as in FIG. 1A with respect to bounding volume 310), then the ray will miss all other smaller bounding volumes inside the bounding volume being tested and any primitives that bounding volume contains.

If the bounding box test performed by the TTU 138 reveals that the bounding volume is intersected by the ray (“Yes” in Step 514), then the TTU determines if the bounding volume can be subdivided into smaller bounding volumes (step 518). In one example embodiment, the TTU 138 isn't necessarily performing any subdivision itself. Rather, each node in the BVH has one or more children (where each child is a leaf or a branch in the BVH). For each child, there is one or more bounding volumes and a pointer that leads to a branch or a leaf node. When a ray processes a node using TTU 138, it is testing itself against the bounding volumes of the node's children. The ray only pushes stack entries onto its stack for those branches or leaves whose representative bounding volumes were hit. When a ray fetches a node in the example embodiment, it doesn't test against the bounding volume of the node - it tests against the bounding volumes of the node's children. The TTU 138 pushes nodes whose bounding volumes are hit by a ray onto the ray's traversal stack in an order determined by ray configuration. For example, it is possible to push nodes onto the traversal stack in the order the nodes appear in memory, or in the order that they appear along the length of the ray, or in some other order. If there are further subdivisions of the bounding volume (“Yes” in step 518), then those further subdivisions of the bounding volume are accessed and the bounding box test is performed for each of the resulting subdivided bounding volumes to determine which subdivided bounding volumes are intersected by the ray and which are not. In this recursive process, some of the bounding volumes may be eliminated by test 514 while other bounding volumes may result in still further and further subdivisions being tested for intersection by TTU 138 recursively applying steps 512-518.

Once the TTU 138 determines that the bounding volumes intersected by the ray are leaf nodes (“No” in step 518), the TTU 138 and/or SM 132 performs a primitive (e.g., triangle) intersection test 520 to determine whether the ray intersects primitives in the intersected bounding volumes and which primitives the ray intersects. The TTU 138 thus performs a depth-first traversal of intersected descendent branch nodes until leaf nodes are reached. The TTU 138 processes the leaf nodes. If the leaf nodes are primitive ranges, the TTU 138 or the SM 132 tests them against the ray. If the leaf nodes are instance nodes, the TTU 138 or the SM 132 applies the instance transform. If the leaf nodes are item ranges, the TTU 138 returns them to the requesting SM 132. In the example non-limiting embodiments, the SM 132 can command the TTU 138 to perform different kinds of ray-primitive intersection tests and report different results depending on the operations coming from an application (or an software stack the application is running on) and relayed by the SM to the TTU. For example, the SM 132 can command the TTU 138 to report the nearest visible primitive revealed by the intersection test, or to report all primitives the ray intersects irrespective of whether they are the nearest visible primitive. The SM 132 can use these different results for different kinds of visualization. Or the SM 132 can perform the ray-primitive intersection test itself once the TTU 138 has reported the ray-complet test results. Once the TTU 138 is done processing the leaf nodes, there may be other branch nodes (pushed earlier onto the ray's stack) to test.

### Example Non-Limiting TTU 138 Hardware Implementation

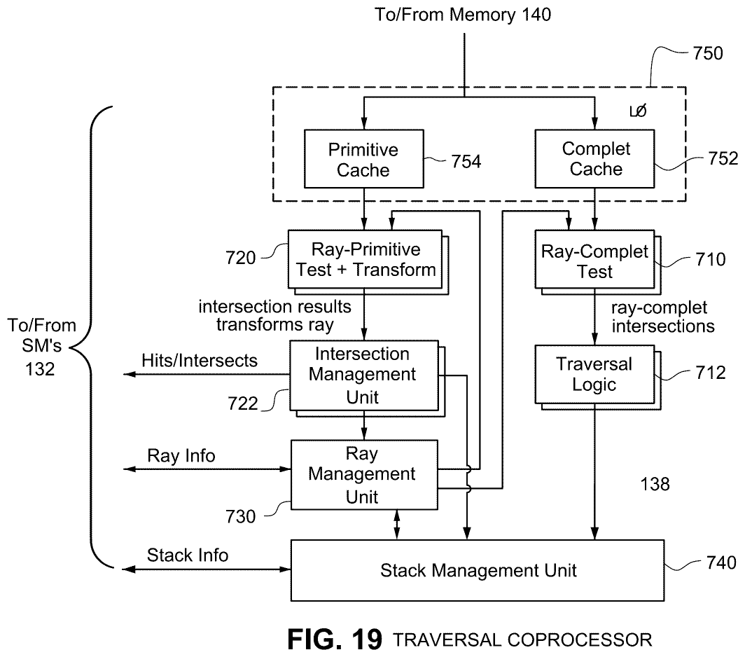

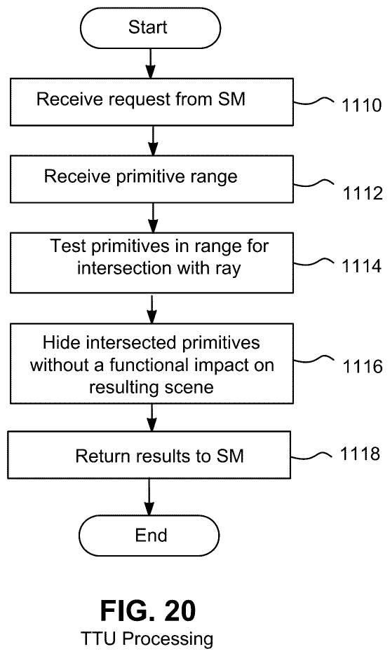

FIG. 19 shows an example simplified block diagram of TTU 138 including hardware configured to perform accelerated traversal operations as described above. In some embodiments, the TTU 138 may perform a depth-first traversal of a bounding volume hierarchy using a short stack traversal with intersection testing of supported leaf node primitives and mid-traversal return of alpha primitives and unsupported leaf node primitives (items). The TTU 138 includes dedicated hardware to determine whether a ray intersects bounding volumes and dedicated hardware to determine whether a ray intersects primitives of the tree data structure.

In more detail, TTU 138 includes an intersection management block 722, a ray management block 730 and a stack management block 740. Each of these blocks (and all of the other blocks in FIG. 19) may constitute dedicated hardware implemented by logic gates, registers, hardware-embedded lookup tables or other combinatorial logic, etc.

The ray management block 730 is responsible for managing information about and performing operations concerning a ray specified by an SM 132 to the ray management block. The stack management block 740 works in conjunction with traversal logic 712 to manage information about and perform operations related to traversal of a BVH acceleration data structure. Traversal logic 712 is directed by results of a ray-complet test block 710 that tests intersections between the ray indicated by the ray management block 730 and volumetric subdivisions represented by the BVH, using instance transforms as needed. The ray-complet test block 710 retrieves additional information concerning the BVH from memory 140 via an L0 complet cache 752 that is part of the TTU 138. The results of the ray-complet test block 710 informs the traversal logic 712 as to whether further recursive traversals are needed. The stack management block 740 maintains stacks to keep track of state information as the traversal logic 712 traverses from one level of the BVH to another, with the stack management block 740 pushing items onto the stack as the traversal logic traverses deeper into the BVH and popping items from the stack as the traversal logic traverses upwards in the BVH. The stack management block 740 is able to provide state information (e.g., intermediate or final results) to the requesting SM 132 at any time the SM requests.

The intersection management block 722 manages information about and performs operations concerning intersections between rays and primitives, using instance transforms as needed. The ray-primitive test block 720 retrieves information concerning geometry from memory 140 on an as-needed basis via an L0 primitive cache 754 that is part of TTU 138. The intersection management block 722 is informed by results of intersection tests the ray-primitive test and transform block 720 performs. Thus, the ray-primitive test and transform block 720 provides intersection results to the intersection management block 722, which reports geometry hits and intersections to the requesting SM 132.

A Stack Management Unit 740 inspects the traversal state to determine what type of data needs to be retrieved and which data path (complet or primitive) will consume it. The intersections for the bounding volumes are determined in the ray-complet test path of the TTU 138 including one or more ray-complet test blocks 710 and one or more traversal logic blocks 712. A complet specifies root or interior nodes of a bounding volume. Thus, a complet may define one or more bounding volumes for the ray-complet test. In example embodiments herein, a complet may define a plurality of “child” bounding volumes that (whether or not they represent leaf nodes) that don't necessarily each have descendants but which the TTU will test in parallel for ray-bounding volume intersection to determine whether geometric primitives associated with the plurality of bounding volumes need to be tested for intersection.

The ray-complet test path of the TTU 138 identifies which bounding volumes are intersected by the ray. Bounding volumes intersected by the ray need to be further processed to determine if the primitives associated with the intersected bounding volumes are intersected. The intersections for the primitives are determined in the ray-primitive test path including one or more ray-primitive test and transform blocks 720 and one or more intersection management blocks 722.

The TTU 138 receives queries from one or more SMs 132 to perform tree traversal operations. The query may request whether a ray intersects bounding volumes and/or primitives in a BVH data structure. The query may identify a ray (e.g., origin, direction, and length of the ray) and a BVH data structure and traversal state (short stack) which includes one or more entries referencing nodes in one or more Bounding Volume Hierarchies that the ray is to visit. The query may also include information for how the ray is to handle specific types of intersections during traversal. The ray information may be stored in the ray management block 730. The stored ray information (e.g., ray length) may be updated based on the results of the ray-primitive test.

The TTU 138 may request the BVH data structure identified in the query to be retrieved from memory outside of the TTU 138. Retrieved portions of the BVH data structure may be cached in the level-zero (L0) cache 750 within the TTU 138 so the information is available for other time-coherent TTU operations, thereby reducing memory 140 accesses. Portions of the BVH data structure needed for the ray-complet test may be stored in a L0 complet cache 752 and portions of the BVH data structure needed for the ray-primitive test may be stored in an L0 primitive cache 754.

After the complet information needed for a requested traversal step is available in the complet cache 752, the ray-complet test block 710 determines bounding volumes intersected by the ray. In performing this test, the ray may be transformed from the coordinate space of the bounding volume hierarchy to a coordinate space defined relative to a complet. The ray is tested against the bounding boxes associated with the child nodes of the complet. In the example non-limiting embodiment, the ray is not tested against the complet's own bounding box because (1) the TTU 138 previously tested the ray against a similar bounding box when it tested the parent bounding box child that referenced this complet, and (2) a purpose of the complet bounding box is to define a local coordinate system within which the child bounding boxes can be expressed in compressed form. If the ray intersects any of the child bounding boxes, the results are pushed to the traversal logic to determine the order that the corresponding child pointers will be pushed onto the traversal stack (further testing will likely require the traversal logic 712 to traverse down to the next level of the BVH). These steps are repeated recursively until intersected leaf nodes of the BVH are encountered

The ray-complet test block 710 may provide ray-complet intersections to the traversal logic 712. Using the results of the ray-complet test, the traversal logic 712 creates stack entries to be pushed to the stack management block 740. The stack entries may indicate internal nodes (i.e., a node that includes one or more child nodes) that need to be further tested for ray intersections by the ray-complet test block 710 and/or triangles identified in an intersected leaf node that need to be tested for ray intersections by the ray-primitive test and transform block 720. The ray-complet test block 710 may repeat the traversal on internal nodes identified in the stack to determine all leaf nodes in the BVH that the ray intersects. The precise tests the ray-complet test block 710 performs will in the example non-limiting embodiment be determined by mode bits, ray operations (see below) and culling of hits, and the TTU 138 may return intermediate as well as final results to the SM 132.

### Ray-Primitive Intersection Testing

Referring again to FIG. 19, the TTU 138 also has the ability to accelerate intersection tests that determine whether a ray intersects particular geometry or primitives enclosed by bounding volumes. For some cases in which the geometry is sufficiently complex (e.g., defined by procedural primitives such as curves or other abstract constructs as opposed to e.g., vertices) that TTU 138 in some embodiments may not be able to help with the ray-primitive intersection testing. In such cases, the TTU 138 simply reports the ray-complet intersection test results to the SM 132, and the SM 132 performs the ray-primitive intersection test itself. In other cases (e.g., triangles), the TTU 138 can perform the ray-triangle intersection test itself, thereby further increasing performance of the overall ray tracing process. For sake of completeness, the following describes how the TTU 138 can perform or accelerate the ray-primitive intersection testing.

As explained above, leaf nodes (found to be intersected by the ray identify (enclose) primitives that may or may not be intersected by the ray. One option is for the TTU 138 to provide e.g., a range of geometry identified in the intersected leaf nodes to the SM 132 for further processing. For example, the SM 132 may itself determine whether the identified primitives are intersected by the ray based on the information the TTU 138 provides as a result of the TTU traversing the BVH. To offload this processing from the SM 132 and thereby accelerate it using the hardware of the TTU 138, the stack management block 740 may issue requests for the ray-primitive and transform block 720 to perform a ray-primitive test for the primitives within intersected leaf nodes the TTU's ray-complet test block 710 identified. In some embodiments, the SM 132 may issue a request for the ray-primitive test to test a specific range of primitives and transform block 720 irrespective of how that geometry range was identified.

After making sure the primitive data needed for a requested ray-primitive test is available in the primitive cache 754, the ray-primitive and transform block 720 may determine primitives that are intersected by the ray using the ray information stored in the ray management block 730. The ray-primitive test block 720 provides the identification of primitives determined to be intersected by the ray to the intersection management block 722.

The intersection management block 722 can return the results of the ray-primitive test to the SM 132. The results of the ray-primitive test may include identifiers of intersected primitives, the distance of intersections from the ray origin and other information concerning properties of the intersected primitives. In some embodiments, the intersection management block 722 may modify an existing ray-primitive test (e.g., by modifying the length of the ray) based on previous intersection results from the ray-primitive and transform block 720.

The intersection management block 722 may also keep track of different types of primitives. For example, the different types of triangles include opaque triangles that will block a ray when intersected and alpha triangles that may or may not block the ray when intersected or may require additional handling by the SM. Whether a ray is blocked or not by a transparent triangle may for example depend on texture(s) mapped onto the triangle, area of the triangle occupied by the texture and the way the texture modifies the triangle. For example, transparency (e.g., stained glass) in some embodiments requires the SM 132 to keep track of transparent object hits so they can be sorted and shaded in ray-parametric order, and typically don't actually block the ray. Meanwhile, alpha “trimming” allows the shape of the primitive to be trimmed based on the shape of a texture mapped onto the primitive—for example, cutting a leaf shape out of a triangle. (Note that in raster graphics, transparency is often called “alpha blending” and trimming is called “alpha test”). In other embodiments, the TTU 138 can push transparent hits to queues in memory for later handling by the SM 132 and directly handle trimmed triangles by sending requests to the texture unit. Each triangle may include a designator to indicate the triangle type. The intersection management block 722 is configured to maintain a result queue for tracking the different types of intersected triangles. For example, the result queue may store one or more intersected opaque triangle identifiers in one queue and one or more transparent triangle identifiers in another queue.

For opaque triangles, the ray intersection for less complex geometry can be fully determined in the TTU 138 because the area of the opaque triangle blocks the ray from going past the surface of the triangle. For transparent triangles, ray intersections cannot in some embodiments be fully determined in the TTU 138 because TTU 138 performs the intersection test based on the geometry of the triangle and may not have access to the texture of the triangle and/or area of the triangle occupied by the texture (in other embodiments, the TTU may be provided with texture information by the texture mapping block of the graphics pipeline). To fully determine whether the triangle is intersected, information about transparent triangles the ray-primitive and transform block 720 determines are intersected may be sent to the SM 132, for the SM to make the full determination as to whether the triangle affects visibility along the ray.

The SM 132 can resolve whether or not the ray intersects a texture associated with the transparent triangle and/or whether the ray will be blocked by the texture. The SM 132 may in some cases send a modified query to the TTU 138 (e.g., shortening the ray if the ray is blocked by the texture) based on this determination. In one embodiment, the TTU 138 may be configured to return all triangles determined to intersect the ray to the SM 132 for further processing. Because returning every triangle intersection to the SM 132 for further processing is costly in terms of interface and thread synchronization, the TTU 138 may be configured to hide triangles which are intersected but are provably capable of being hidden without a functional impact on the resulting scene. For example, because the TTU 138 is provided with triangle type information (e.g., whether a triangle is opaque or transparent), the TTU 138 may use the triangle type information to determine intersected triangles that are occluded along the ray by another intersecting opaque triangle and which thus need not be included in the results because they will not affect the visibility along the ray. If the TTU 138 knows that a triangle is occluded along the ray by an opaque triangle, the occluded triangle can be hidden from the results without impact on visualization of the resulting scene.

The intersection management block 722 may include a result queue for storing hits that associate a triangle ID and information about the point where the ray hit the triangle. When a ray is determined to intersect an opaque triangle, the identity of the triangle and the distance of the intersection from the ray origin can be stored in the result queue. If the ray is determined to intersect another opaque triangle, the other intersected opaque triangle can be omitted from the result if the distance of the intersection from the ray origin is greater than the distance of the intersected opaque triangle already stored in the result queue. If the distance of the intersection from the ray origin is less than the distance of the intersected opaque triangle already stored in the result queue, the other intersected opaque triangle can replace the opaque triangle stored in the result queue. After all of the triangles of a query have been tested, the opaque triangle information stored in the result queue and the intersection information may be sent to the SM 132.

In some embodiments, once an opaque triangle intersection is identified, the intersection management block 722 may shorten the ray stored in the ray management block 730 so that bounding volumes (which may include triangles) behind the intersected opaque triangle (along the ray) will not be identified as intersecting the ray.

The intersection management block 722 may store information about intersected transparent triangles in a separate queue. The stored information about intersected transparent triangles may be sent to the SM 132 for the SM to resolve whether or not the ray intersects a texture associated with the triangle and/or whether the texture blocks the ray. The SM may return the results of this determination to the TTU 138 and/or modify the query (e.g., shorten the ray if the ray is blocked by the texture) based on this determination.

As discussed above, the TTU 138 allows for quick traversal of an acceleration data structure (e.g., a BVH) to determine which primitives (e.g., triangles used for generating a scene) in the data structure are intersected by a query data structure (e.g., a ray). For example, the TTU 138 may determine which triangles in the acceleration data structure are intersected by the ray and return the results to the SM 132. However, returning to the SM 132 a result on every triangle intersection is costly in terms of interface and thread synchronization. The TTU 138 provides a hardware logic configured to hide those items or triangles which are provably capable of being hidden without a functional impact on the resulting scene. The reduction in returns of results to the SM and synchronization steps between threads greatly improves the overall performance of traversal. The example non-limiting embodiments of the TTU 138 disclosed in this application provides for some of the intersections to be discarded within the TTU 138 without SM 132 intervention so that less intersections are returned to the SM 132 and the SM 132 does not have to inspect all intersected triangles or item ranges.

### Example Instancing Pipeline Implementation By TTU 138 and SM 132

The following describes how TTU 138 in example embodiments performs instancing and associated transforms.

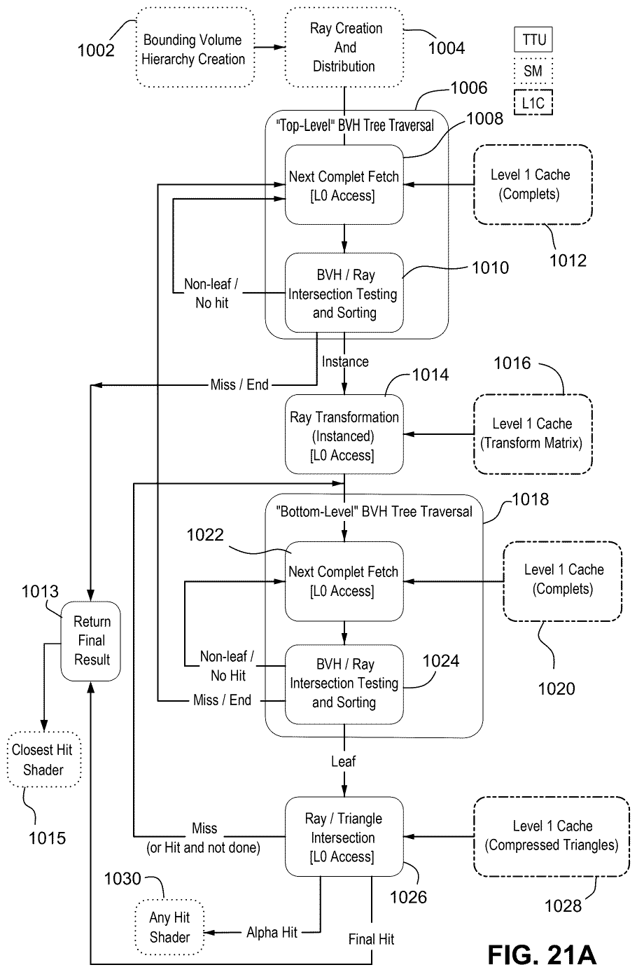

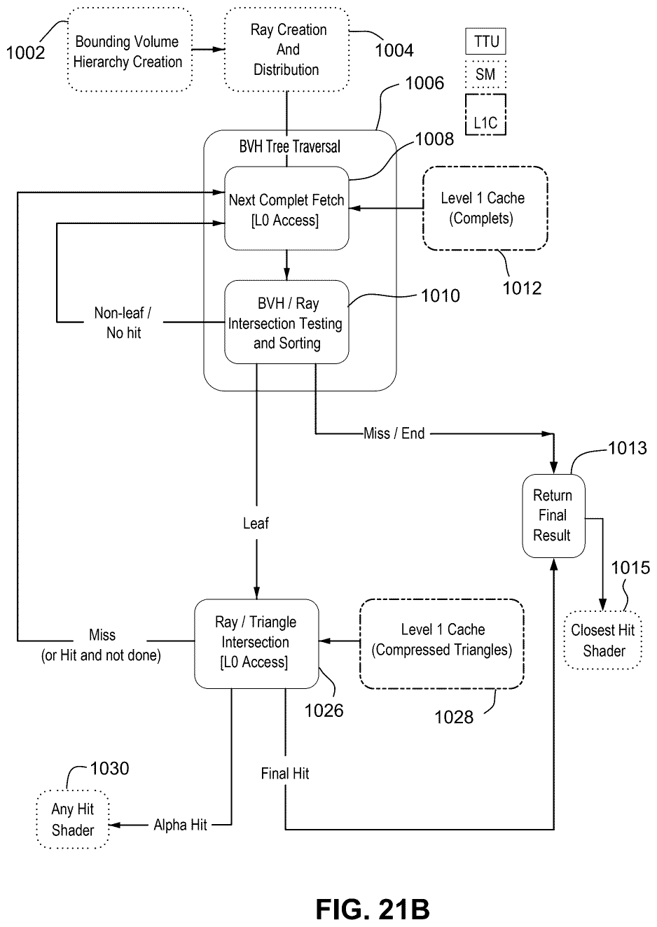

The FIG. 21A more detailed diagram of a ray-tracing pipeline flowchart shows the data flow and interaction between components for a representative use case: tracing rays against a scene containing geometric primitives, with instance transformations handled in hardware. In one example non-limiting embodiment, the ray-tracing pipeline of FIG. 21A is essentially software-defined (which in example embodiments means it is determined by the SMs 132) but makes extensive use of hardware acceleration by TTU 138. Key components include the SM 132 (and the rest of the compute pipeline), the TTU 138 (which serves as a coprocessor to SM), and the L1 cache and downstream memory system, from which the TTU fetches BVH and triangle data.

The pipeline shown in FIG. 21A shows that bounding volume hierarchy creation 1002 of an AS can be performed ahead of time by a development system and/or in real time just prior to display of a new video frame. It also shows that ray creation and distribution 1004 are performed or controlled by the SM 132 or other software in the example embodiment, as shading (which can include lighting and texturing). The example pipeline includes a “top level” BVH tree traversal 1006, ray transformation 1014, “bottom level” BVH tree traversal 1018, and a ray/triangle (or other primitive) intersection 1026 that are each performed by the TTU 138. These do not have to be performed in the order shown, as handshaking between the TTU 138 and the SM 132 determines what the TTU 138 does and in what order.

The SM 132 presents one or more rays to the TTU 138 at a time. Each ray the SM 132 presents to the TTU 138 for traversal may include the ray's geometric parameters, traversal state, and the ray's ray flags, mode flags and ray operations information. In an example embodiment, a ray operation (RayOp) provides or comprises an auxiliary arithmetic and/or logical test to suppress, override, and/or allow storage of an intersection. The traversal stack may also be used by the SM 132 to communicate certain state information to the TTU 138 for use in the traversal. A new ray query may be started with an explicit traversal stack. For some queries, however, a small number of stack initializers may be provided for beginning the new query of a given type, such as, for example: traversal starting from a particular complet; intersection of a ray with a range of triangles; intersection of a ray with a range of triangles, followed by traversal starting from a complet; vertex fetch from a triangle buffer for a given triangle, etc. In some embodiments, using stack initializers instead of explicit stack initialization improves performance because stack initializers require fewer streaming processor registers and reduce the number of parameters that need to be transmitted from the streaming processor to the TTU.

In the example embodiment, a set of mode flags the SM 132 presents with each query (e.g., ray) may at least partly control how the TTU 138 will process the query when the query intersects the bounding volume of a specific type or intersects a primitive of a specific primitive type. The mode flags the SM 132 provides to the TTU 138 enable the ability by the SM and/or the application to e.g., through a RayOp, specify an auxiliary arithmetic or logical test to suppress, override, or allow storage of an intersection. The mode flags may for example enable traversal behavior to be changed in accordance with such aspects as, for example, a depth (or distance) associated with each bounding volume and/or primitive, size of a bounding volume or primitive in relation to a distance from the origin or the ray, particular instances of an object, etc. This capability can be used by applications to dynamically and/or selectively enable/disable sets of objects for intersection testing versus specific sets or groups of queries, for example, to allow for different versions of models to be used when application state changes (for example, when doors open or close) or to provide different versions of a model which are selected as a function of the length of the ray to realize a form of geometric level of detail, or to allow specific sets of objects from certain classes of rays to make some layers visible or invisible in specific views.

In addition to the set of mode flags which may be specified separately for the ray-complet intersection and for ray-primitive intersections, the ray data structure may specify other RayOp test related parameters, such as ray flags, ray parameters and a RayOp test. The ray flags can be used by the TTU 138 to control various aspects of traversal behavior, back-face culling, and handling of the various child node types, subject to a pass/fail status of an optional RayOp test. RayOp tests add flexibility to the capabilities of the TTU 138, at the expense of some complexity. The TTU 138 reserves a “ray slot” for each active ray it is processing, and may store the ray flags, mode flags and/or the RayOp information in the corresponding ray slot buffer within the TTU during traversal.

In the example shown in FIG. 21A, the TTU 138 performs a top level tree traversal 1006 and a bottom level tree traversal 1018. In the example embodiment, the two level instance traversal of the BVH enables fast ray tracing responses to dynamic scene changes.

Ray transformation 1014 provides the appropriate transition from the top level tree traversal 1006 to the bottom level tree traversal 1018 by transforming the ray, which may be used in the top level traversal in a first coordinate space (e.g., world space), to a different coordinate space (e.g., object space) of the BVH of the bottom level traversal. An example BVH traversal technique using a two level traversal is described in previous literature, see, e.g., Woop, “A Ray Tracing Hardware Architecture for Dynamic Scenes”, Universitat des Saarlandes, 2004, but embodiments are not limited thereto.

### Example Top Level Tree Traversal

The top level tree traversal 1006 by TTU 138 receives complets from the L1 cache 1012, and provides an instance to the ray transformation 1014 for transformation, or a miss/end output 1013 to the SM 132 for closest hit shader 1015 processing by the SM (this block can also operate recursively based on non-leaf nodes/no hit conditions). In the top level tree traversal 1006, a next complet fetch step 1008 fetches the next complet to be tested for ray intersection in step 1010 from the memory and/or cache hierarchy and ray-bounding volume intersection testing is done on the bounding volumes in the fetched complet.

As described above, an instance node connects one BVH to another BVH which is in a different coordinate system. When a child of the intersected bounding volume is an instance node, the ray transformation 1014 is able to retrieve an appropriate transform matrix from the L1 cache 1016. The TTU 138, using the appropriate transform matrix, transforms the ray to the coordinate system of that particular child BVH. U.S. patent application Ser. No. 14/697,480 describes transformation nodes that connect a first set of nodes in a tree to a second set of nodes where the first and second sets of nodes are in different coordinate systems. The instance nodes in example embodiments may be similar to the transformation nodes in U.S. application Ser. No. 14/697,480. In an alternative, non-instancing mode of TTU 138 shown in FIG. 21B, the TTU does not execute a “bottom” level tree traversal 1018 and noninstanced tree BVH traversals are performed by blocks 1008, 1010 e.g., using only one stack. The TTU 138 can switch between the FIG. 21A instanced operations and the FIG. 21B non-instanced operations based on what it reads from the BVH and/or query type. For example, a specific query type may restrict the TTU to use just the non-instanced operations. In such a query, any intersected instance nodes would be returned to the SM.

In some non-limiting embodiments, ray-bounding volume intersection testing in step 1010 is performed on each bounding volume in the fetched complet before the next complet is fetched. Other embodiments may use other techniques, such as, for example, traversing the top level traversal BVH in a depth-first manner. U.S. Pat. No. 9,582,607 describes one or more complet structures and contents that may be used in example embodiments. U.S. Pat. No. 9,582,607 also describes an example traversal of complets.

When a bounding volume is determined to be intersected by the ray, the child bounding volumes (or references to them) of the intersected bounding volume are kept track of for subsequent testing for intersection with the ray and for traversal. In example embodiments, one or more stack data structures is used for keeping track of child bounding volumes to be subsequently tested for intersection with the ray. In some example embodiments, a traversal stack of a small size may be used to keep track of complets to be traversed by operation of the top level tree traversal 1006, and primitives to be tested for intersection, and a larger local stack data structure can be used to keep track of the traversal state in the bottom level tree traversal 1018.

### Example Bottom Level Tree Traversal

In the bottom level tree traversal 1018, a next complet fetch step 1022 fetches the next complet to be tested for ray intersection in step 1024 from the memory and/or cache hierarchy 1020 and ray-bounding volume intersection testing is done on the bounding volumes in the fetched complet. The bottom level tree traversal, as noted above, may include complets with bounding volumes in a different coordinate system than the bounding volumes traversed in the upper level tree traversal. The bottom level tree traversal also receives complets from the L1 cache and can operate recursively or iteratively within itself based on non-leaf/no-hit conditions and also with the top level tree traversal 1006 based on miss/end detection. Intersections of the ray with the bounding volumes in the lower level BVH may be determined with the ray transformed to the coordinate system of the lower level complet retrieved. The leaf bounding volumes found to be intersected by the ray in the lower level tree traversal are then provided to the ray/triangle intersection 1026.

The leaf outputs of the bottom level tree traversal 1018 are provided to the ray/triangle intersection 1026 (which has L0 cache access as well as ability to retrieve triangles via the L1 cache 1028). The L0 complet and triangle caches may be small read-only caches internal to the TTU 138. The ray/triangle intersection 1026 may also receive leaf outputs from the top level tree traversal 1006 when certain leaf nodes are reached without traversing an instanced BVH.

After all the primitives in the primitive range have been processed, the Intersection Management Unit inspects the state of the result Queue and crafts packets to send to the Stack Management Unit and/or Ray Management Unit to update the ray's attributes and traversal state, set up the ray's next traversal step, and/or return the ray to the SM 132 (if necessary). If the result queue contains opaque or alpha intersections found during the processing of the primitive range then the Intersection Management Unit signals the parametric length (t) of the nearest opaque intersection in the result queue to the ray management unit to record as the ray's tmax to shorten the ray. To update the traversal state to set up the ray's next traversal step the Intersection Management Unit signals to the Stack Management Unit whether an opaque intersection from the primitive range is present in the resultQueue, whether one or more alpha intersections are present in the result queue, whether the resultQueue is full, whether additional alpha intersections were found in the primitive range that have not been returned to the SM and which are not present in the resultQueue, and the index of the next alpha primitive in the primitive range for the ray to test after the SM consumes the contents of the resultQueue (the index of the next primitive in the range after the alpha primitive with the highest memory-order from the current primitive range in the result queue).

When the Stack Management Unit 740 receives the packet from Intersection Management Unit 722, the Stack Management Unit 740 inspects the packet to determine the next action required to complete the traversal step and start the next one. If the packet from Intersection Management Unit 722 indicates an opaque intersection has been found in the primitive range and the ray mode bits indicate the ray is to finish traversal once any intersection has been found the Stack Management Unit 740 returns the ray and its results queue to the SM with traversal state indicating that traversal is complete (a done flag set and/or an empty top level and bottom level stack). If the packet from Intersection Management Unit 722 indicates that there are opaque or alpha intersection in the result queue and that there are remaining alpha intersections in the primitive range not present in the result queue that were encountered by the ray during the processing of the primitive range that have not already been returned to the SM, the Stack Management Unit 740 returns the ray and the result queue to the SM with traversal state modified to set the cull opaque bit to prevent further processing of opaque primitives in the primitive range and the primitive range starting index advanced to the first alpha primitive after the highest alpha primitive intersection from the primitive range returned to the SM in the ray's result queue. If the packet from Intersection Management Unit 722 indicates that no opaque or alpha intersections were found when the ray processed the primitive range the Stack Management Unit 740 pops the top of stack entry (corresponding to the finished primitive range) off the active traversal stack. If the packet from Stack Management Unit 740 indicates or that either there are opaque intersections in the result queue and the ray mode bits do not indicate that the ray is to finish traversal once any intersection has been found and/or there are alpha intersections in the result queue, but there were no remaining alpha intersections found in the primitive range not present in the result queue that have not already been returned to the SM, the Stack Management Unit 740 pops the top of stack entry (corresponding to the finished primitive range) off the active traversal stack and modifies the contents of the result queue to indicate that all intersections present in the result queue come from a primitive range whose processing was completed.

If the active stack is the bottom stack, and the bottom stack is empty the Stack Management Unit 740 sets the active stack to the top stack. If the top stack is the active stack, and the active stack is empty, then the Stack Management Unit 740 returns the ray and its result queue to the SM with traversal state indicating that traversal is complete (a done flag set and/or an empty top level and bottom level stack). If the active stack contains one or more stack entries, then the Stack Management Unit 740 inspects the top stack entry and starts the next traversal step. Testing of primitive and/or primitive ranges for intersections with a ray and returning results to the SM 132 are described in co-pending U.S. application Ser. No. 16/101,148 entitled “Conservative Watertight Ray Triangle Intersection” and U.S. application Ser. No. 16/101,196 entitled “Method for Handling Out-of-Order Opaque and Alpha Ray/Primitive Intersections”, which are hereby incorporated by reference in their entireties.

### Example Image Generation Pipeline Including Ray Tracing

While the above disclosure is framed in the specific context of computer graphics and visualization, ray tracing and the disclosed TTU could be used for a variety of applications beyond graphics and visualization. Non-limiting examples include sound propagation for realistic sound synthesis, simulation of sonar systems, design of optical elements and systems, particle transport simulation (e.g., for medical physics or experimental high-energy physics), general wave propagation simulation, comparison to LIDAR data for purposes e.g., of robot or vehicle localization, and others. OptiX™ has already been used for some of these application areas in the past.

For example, the ray tracing and other capabilities described above can be used in a variety of ways. For example, in addition to being used to render a scene using ray tracing, they may be implemented in combination with scan conversion techniques such as in the context of scan converting geometric building blocks (i.e., polygon primitives such as triangles) of a 3D model for generating image for display (e.g., on display 150 illustrated in FIG. 9).

Meanwhile, however, the technology herein provides advantages when used to produce images for virtual reality, augmented reality, mixed reality, video games, motion and still picture generation, and other visualization applications. FIG. 19 illustrates an example flowchart for processing primitives to provide image pixel values of an image, in accordance with an embodiment. As FIG. 15 shows, an image of a 3D model may be generated in response to receiving a user input (Step 1652). The user input may be a request to display an image or image sequence, such as an input operation performed during interaction with an application (e.g., a game application). In response to the user input, the system performs scan conversion and rasterization of 3D model geometric primitives of a scene using conventional GPU 3D graphics pipeline (Step 1654). The scan conversion and rasterization of geometric primitives may include for example processing primitives of the 3D model to determine image pixel values using conventional techniques such as lighting, transforms, texture mapping, rasterization and the like as is well known to those skilled in the art. The generated pixel data may be written to a frame buffer.

In step 1656, one or more rays may be traced from one or more points on the rasterized primitives using TTU hardware acceleration. The rays may be traced in accordance with the one or more ray-tracing capabilities disclosed in this application. Based on the results of the ray tracing, the pixel values stored in the buffer may be modified (Step 1658). Modifying the pixel values may in some applications for example improve the image quality by, for example, applying more realistic reflections and/or shadows. An image is displayed (Step 1660) using the modified pixel values stored in the buffer.

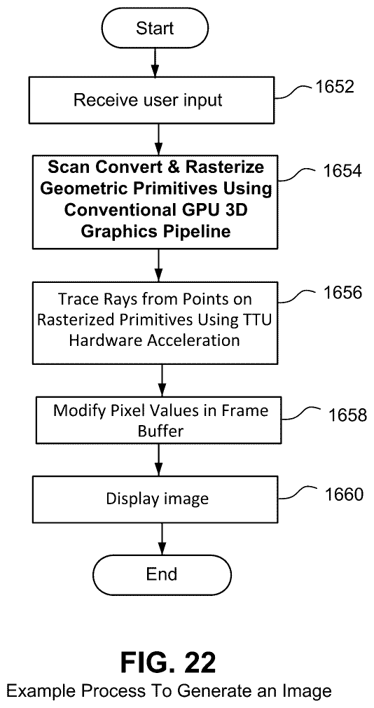

In one example, scan conversion and rasterization of geometric primitives may be implemented using the processing system described above, and ray tracing may be implemented by the SM's 132 using the TTU architecture described in relation to FIG. 19, to add further visualization features (e.g., specular reflection, shadows, etc.). FIG. 22 is just a non-limiting example—the SM's 132 could employ the described TTU by itself without texture processing or other conventional 3D graphics processing to produce images, or the SM's could employ texture processing and other conventional 3D graphics processing without the described TTU to produce images. The SM's can also implement any desired image generation or other functionality in software depending on the application to provide any desired programmable functionality that is not bound to the hardware acceleration features provided by texture mapping hardware, tree traversal hardware or other graphics pipeline hardware.

The TTU 138 in some embodiments is stateless, meaning that no architectural state is maintained in the TTU between queries. At the same time, it is often useful for software running on the SM 1840 to request continuation of a previous query, which implies that relevant state should be written to registers by the TTU 138 and then passed back to the TTU in registers (often in-place) to continue. This state may take the form of a traversal stack that tracks progress in the traversal of the BVH.

The TTU 138 in some embodiments can handle one level of instancing natively by transforming the ray into the coordinate system of the instance BVH. Additional levels of instancing (or every other level of instancing, depending on strategy) may be handled in software (or in other embodiments, the TTU 138 hardware can handle two, three or more levels of instancing). The “InstanceNode” hit type is provided for this purpose, consisting of a pointer to the instance node and the tvalue of the intersection with the leaf bounding box. In other implementations, as described above, the hardware can handle two levels of instancing with a third pseudo-instance level.

All patents and publications cited herein are incorporated by reference as if expressly set forth.

While the invention has been described in connection with what is presently considered to be the most practical and preferred embodiments, it is to be understood that the invention(s) is/area not to be limited to the disclosed embodiments. For example, even though the described embodiments provide particular advantages for level of detail swapping, the technology could be used without any LOD or other swapping, in order to provide AS segmentation and associated parallelism of quick, hierarchical AS builds. While example embodiments are described in connection with ray tracing, the improved BVH acceleration structure and associated building and processing could be used by rendering or any other process that producing visualization or other information from a BVH acceleration structure. Therefore, on the contrary, the invention(s) is/are intended to cover various modifications and equivalent arrangements included within the spirit and scope of the appended claims.

1. A non-transitory memory storing an acceleration structure configured to control a graphics generator to generate a visualization, the acceleration structure comprising:
a first level acceleration structure including an instance node;
a second level acceleration structure linked to the first level acceleration structure, the second level acceleration structure including a pseudo-instance node; and
a third level acceleration structure linked to the second level acceleration structure by the pseudo-instance node,
wherein the acceleration structure defines a coordinate transform between the second level acceleration structure and the first level acceleration structure but defines no additional coordinate transform between the third level acceleration structure and the second level acceleration structure.

2. The non-transitory memory of claim 1 wherein the second level acceleration structure is configured to apply the coordinate transform to transform geometry represented by the third level acceleration structure from object space to world space.

3. The non-transitory memory of claim 2 wherein the geometry comprises a triangle cluster.

4. The non-transitory memory of claim 1 wherein the pseudo-instance node comprises a pointer to the third level acceleration structure.

5. The non-transitory memory of claim 1 wherein the second level acceleration structure comprises a first pseudo-instance node linking the second level acceleration structure to a first third level acceleration structure and a second pseudo-instance node linking the second level acceleration structure to a second third level acceleration structure.

6. The non-transitory memory of claim 1 wherein the third level acceleration structure is linked to by a plurality of second level acceleration structures.

7. The non-transitory memory of claim 1 wherein the first level acceleration structure comprises a first group acceleration structure and a second group acceleration structure, and a further pseudo-instance node links a top level acceleration structure root to each of the first group acceleration structure and the second group acceleration structure.

8. The non-transitory memory of claim 1 wherein the pseudo-instance node comprises a multiplicity of pointers that point to a corresponding multiplicity of third level acceleration structures, the pointers comprising absolute or relative memory addresses.

9. Graphics generation hardware comprising:
a memory interface configured to read an acceleration structure comprising:
a first level acceleration structure including an instance node,
a second level acceleration structure linked to the first level acceleration structure, the second level acceleration structure including a pseudo-instance node, and
a third level acceleration structure linked to the second level acceleration structure by the pseudo-instance node,
the acceleration structure defining a coordinate transform between the second level acceleration structure and the first level acceleration structure but defining no additional coordinate transform between the third level acceleration structure and the second level acceleration structure;
a stack configured to store traversal of the acceleration structure, the acceleration structure further configuring the stack to prevent overwriting of a back track pointer from the third level acceleration structure to the second level acceleration structure; and
a ray-geometry intersection testing circuit that applies the coordinate transform to transform geometry represented by the third level acceleration structure into a coordinate space of a ray.

10. A method of generating graphics comprising:
(a) accessing a TLAS acceleration structure;
(b) accessing a BLAS acceleration structure through the TLAS acceleration structure including obtaining a transform;
(c) using a pseudo-instance node associated with the BLAS acceleration structure to access a CLAS acceleration structure defining geometry; and
(d) applying the transform to transform the geometry into a coordinate system associated with the TLAS acceleration structure.

11. A method of building an acceleration structure by automatically performing, with at least one processor or processing circuit, operations comprising:
accessing at least one geometry cluster and using it to generate at least one corresponding CLAS;
constructing at least one BLAS over the at least one corresponding CLAS using at least one of PIN and MPRC;
constructing at least one TLAS over the at least one BLAS; and
writing to memory an acceleration structure comprising the generated at least one corresponding CLAS, the at least one BLAS, and the at least one TLAS.

12. The method of claim 11 wherein constructing at least one TLAS over the at least one BLAS comprises:
constructing a plurality of group TLASes over the at least one BLAS;
constructing a TLAS over the plurality of group TLASes; and
linking the TLAS with the plurality of group TLASes with at least one PIN.

13. The method of claim 11 wherein the at least one BLAS and the at least one TLAS each define an instance transform whereas the PIN does not.

14. The method of claim 11 wherein the PIN comprises a multiplicity of CLAS pointers.

15. The method of claim 14 wherein the CLAS pointers are absolute addresses.

16. The method of claim 14 wherein the CLAS pointers are relative addresses.

17. The method of claim 11 wherein the at least one BLAS comprises at least one implicit address pointing to the PIN, and the comprises an absolute or relative address pointing to the at least one corresponding CLAS.

18. The method of claim 11 wherein the MPRC enables the at least one corresponding CLAS to be called by any of plural BLASes.

19. A hardware ray tracing circuit comprising:
a memory interface that reads portions of an acceleration structure from memory;
a bounding box test circuit that culls acceleration structure nodes based on non-intersection of a ray with defined bounding boxes;
a ray-geometry intersection circuit that tests geometry of non-culled acceleration structure nodes for intersection with the ray after transforming the ray from world space to object space of the geometry; and
a stack that tracks visited nodes, the stack further storing an indication that a visited node it is a root complet having multi-parent/limited stack root.

20. The hardware ray tracing circuit of claim 19 wherein the stack is further structured to lock an entry used to continue traversal to a particular one of multi-parent nodes.
